(19) United States
(12) Patent Application Publication
(10) Pub. No.: US 2025/0200103 A1
(43) Pub. Date: Jun. 19, 2025

(54) MEDIA CONTENT PROCESSING FOR CHARACTERISTIC EXTRACTION AND ANALYSIS

(71) Applicant: Invisible Holdings LLC, Sheridan, WY (US)

(72) Inventors: Raymond Francis St. Martin, Felton, CA (US); Andrew Lee Van Valer, Reno, NV (US)

(21) Appl. No.: 18/977,947

(22) Filed: Dec. 12, 2024

Related U.S. Application Data
(60) Provisional application No. 63/609,602, filed on Dec. 13, 2023.

(51) Int. Cl. G06F 16/438; G06F 16/435

(52) U.S. Cl. CPC G06F 16/438; G06F 16/435

(57) ABSTRACT

Media processing systems and techniques are described. In some examples, a media processing system analyzes media content to identify a plurality of media characteristics of the media content. The media processing system analyzes one of the plurality of media characteristics to extract a plurality of data elements. The plurality of data elements is associated with a creation of the media content. The media processing system outputs an arrangement of at least a subset of the plurality of data elements.

### CROSS-REFERENCE TO RELATED APPLICATIONS

The present application claims the priority benefit of U.S. Provisional Patent Application No. 63/609,602 filed on Dec. 13, 2023, entitled “Multiple Creator Attribution for Music Recordings,” the disclosures of which is all incorporated herein by reference in its entirety.

### FIELD OF THE DISCLOSURE

The present disclosure is generally related to media content analysis and attribution, and more particularly relating to processing, scoring, and storing media content data based on media content characteristics, data sources, and data types, among other parameters.

### BACKGROUND

When tracking data associated with the creation of a media content, it is difficult to capture the richness and depth of its creative process especially when combining different sources. Each media content can have its own narratives, concepts, attribution, interpretation, and/or source materials and sources. Therefore, it is desirable to devise a way to consolidate this information in search of accuracy and comprehensive understanding of a media content.

### SUMMARY

Examples of the present technology include a method, a system, and a non-transitory computer readable storage medium for processing media content(s). In some examples, a media processing system analyzes media content to identify a plurality of media characteristics of the media content. The media processing system analyzes one of the plurality of media characteristics to extract a plurality of data elements. The plurality of data elements is associated with a creation of the media content. The media processing system outputs an arrangement of at least a subset of the plurality of data elements.

In some examples, a method for media processing includes analyzing media content to identify a plurality of media characteristics of the media content. The method includes analyzing one of the plurality of media characteristics to extract a plurality of data elements. The plurality of data elements is associated with a creation of the media content. The method includes outputting an arrangement of at least a subset of the plurality of data elements.

In some examples, a system for media processing includes a memory and a processor that executes instructions in memory. Execution of the instructions by the processor causes the processor to perform operations. The operations include analyzing media content to identify a plurality of media characteristics of the media content. The operations include analyzing one of the plurality of media characteristics to extract a plurality of data elements. The plurality of data elements is associated with a creation of the media content. The operations include outputting an arrangement of at least a subset of the plurality of data elements.

In some examples, a non-transitory computer-readable storage medium has a program executable by a processor to perform a method for media processing. The method includes analyzing media content to identify a plurality of media characteristics of the media content. The method includes analyzing one of the plurality of media characteristics to extract a plurality of data elements. The plurality of data elements is associated with a creation of the media content. The method includes outputting an arrangement of at least a subset of the plurality of data elements.

### BRIEF DESCRIPTION OF THE DRAWINGS

FIG. 1 is a block diagram illustrating an architecture of a media attribution system, according to some examples.

FIG. 2 is a table illustrating exemplary details about different exemplary types of source data, in accordance with some examples.

FIG. 3 is a table illustrating exemplary details about different exemplary types of event data, in accordance with some examples.

FIG. 4 is a table illustrating exemplary details about different exemplary types of location data, in accordance with some examples.

FIG. 5 is a table illustrating exemplary details about different exemplary types of subject data, in accordance with some examples.

FIG. 6 is a table illustrating exemplary details about different exemplary types of creator data, in accordance with some examples.

FIG. 7 is a table illustrating exemplary details about different exemplary types of equipment data, in accordance with some examples.

FIGS. 8A-C are tables illustrating exemplary details about different exemplary types of concept data, in accordance with some examples.

FIG. 9 is a flow diagram illustrating a process performed by a server system, in accordance with some examples.

FIG. 10 is a flow diagram illustrating a process performed by data collection module, in accordance with some examples.

FIG. 11 is a flow diagram illustrating a process performed by a subject module, in accordance with some examples.

FIG. 12 is a flow diagram illustrating a process performed by an event module, in accordance with some examples.

FIG. 13 is a flow diagram illustrating a process performed by a location module, in accordance with some examples.

FIG. 14 is a flow diagram illustrating a process performed by a perspective module, in accordance with some examples.

FIG. 15 is a flow diagram illustrating a process performed by a creator module, in accordance with some examples.

FIG. 16 is a flow diagram illustrating a process performed by an equipment module, in accordance with some examples.

FIG. 17 is a flow diagram illustrating a process performed by a concept module, in accordance with some examples.

FIG. 18 is a block diagram illustrating an example of a machine learning system, in accordance with some examples.

FIG. 19 is a flow diagram illustrating an example of a process for media processing, in accordance with some examples.

### DETAILED DESCRIPTION

Many of the embodiments described herein are described in terms of sequences of actions to be performed by, for example, elements of a computing device. It should be recognized by those skilled in the art that specific circuits can perform the various sequence of actions described herein (e.g., application-specific integrated circuits (ASICs)) and/or by program instructions executed by at least one processor. Additionally, the sequence of actions described herein can be embodied within any form of computer-readable storage medium such that execution of the sequence of actions enables the processor to perform the functionality described herein.

Transcriptions, audio, and video recordings are provided with information generally relating to surface information such as creator or producer of the music, or name of the production house. In addition to the surface information, a comprehensive set of digital record associated with the musical works may be provided and stored for richness and depth of information. In some examples, the comprehensive set of digital record may include crucial contributors to a music piece, such as audio engineers, mixers, session musicians, detailed data about the musical concepts employed, the specific equipment used, and narratives surrounding the creation, which capture the richness and depth of the creation of the musical works.

Additionally, music recordings may be associated with related digital collectibles, such as non-fungible tokens (NFTs), and may be associated with creator attribution with Digital Audio Workstations (DAWs), which are commonly used in music production.

Storing and retrieving the comprehensive set of digital record at the time of creation of the musical works can be enhanced by using a Social Identity of Objects (SIO) system, which may be implemented using the systems and methods discussed herein.

An SIO system, and its technical framework of data and information, seamlessly associate all relevant information about a specific music recording and provide an increasingly valuable currency as a repository, sharing, and exchange platform. Examples of the SIO system may comprise the aggregation of a plurality of data sources and types of data to create a cohesive narrative, story, timeline, view of relationships, or account of a music recording or collection of music recordings. An aggregation of data related to a person, place, and/or event from a plurality of sources may provide a more complete description of said person, place, and/or event, including context which might otherwise be overlooked or missing. Additionally, intrinsic energy is fundamental to the existence, transformation, and interaction of all things in the universe, reflecting the interconnected nature of data, objects, and narratives within the SIO system.

The conventional conception of a physical music recording is that it exists in the physical world. For instance, media (such as music) can be encoded or otherwise stored in a physical music recording medium or other physical body. An object boundary may change over time, but it has a visible or tangible surface and specific properties. The aggregation of data from a plurality of sources may facilitate the creation of a story or timeline of events which may document changes to the media (e.g., the music) and/or changes to the object that the music is encoded or stored in.

In some examples, there can be a newly launched piece of music released in a particular movie. This newly launched piece may have unique properties that are particular to the piece, such as a producer of the music, a singer of the music, or an editor of the music, or a combination thereof. Therefore, one single music may have infinite properties attached to it. Therefore, a tangible or non-tangible object has an identity that may change over time, with changes capable of being tracked and annotated in real-time. The initial identity of a music recording may change based on outside physical forces or input but can also be augmented and amplified by information associated with the music recording itself. Such properties may be provided from a plurality of sources which may then be associated with similar accounts to create a more complete collection of properties describing the music recording.

The current technology allows an individual to interface with various devices that enable an enhanced understanding of the status and context of a media content. In some examples, audio sensors can monitor systems and operating components of a music studio, and digital audio workstations can help individuals understand more about their music's acoustic characteristics and performance. Music recordings can now combine technologies from multiple areas and integrate them into new infrastructures, providing a more robust and contextual experience for the listener. As this process continues to grow and develop, every physical music recording can be identified with a unique internet address, allowing additional ways to experience and interact with music and associated events connected to those recordings. The contextual information associated with physical music recordings shape how users interact and connect to the physical and virtual worlds. A plurality of data types, formats, sources, or a combination thereof, may be used to compile a story about a person, place, event, music recording, or a combination thereof. Likewise, the interfaces for interacting with such stories may comprise any of a traditional display, a holographic display, augmented reality, virtual reality, or a combination thereof. In some examples, the interface may comprise audio or a combination of two or more interfaces. Interfaces may further allow for interaction with other users.

Accelerating technological developments can allow people to interaction with music recordings on a new level in the virtual world via augmented reality (AR) and artificial intelligence (AI) capabilities. Information layers associated with music recordings and narratives from various sources can be associated with specific music recordings, events, and products-enhancing value, engagement, and relationships with these music recordings, essentially creating a mixed reality environment with the convergence and synchronization of the real and virtual worlds. The SIO is implementing a personal approach to capturing, analyzing, and displaying music data, realizing that subjectivity and context can play a defining role in understanding music, events, social changes, and culture.

The systems and methods discussed herein are associated with processes of discovering music recordings through a system of relationships, attributes, and context of specific music recordings. Searches can be made in various ways and can be associated with a single type or choice of the different types of searches outlined hereafter in this document. The searches can be made based on any attributes or relationships of the SIOs within a single database or group of public or private databases.

Search examples can include genre, length, release date, record label, album size, and relationships to other SIOs connecting unlimited associations or attributes attached with each type of registered or non-registered user by a menu-driven by choices.

Individual users may deploy unique search criteria based on their specific requirements. For example, a consumer may wish to see the complete narrative history of a song or album in any possible view-limited, for instance, to publicly available information only. Conversely, an individual may wish to explore the history of a song (e.g., classic rock anthem) through associated narratives or stories and recollections via a network of private databases.

A music producer can choose to see the entirety of details and attributes of all contributing musicians, instruments used, recording equipment, associated music technologies and processes, and the timeline of events from the time of song conception throughout its entire lifecycle (e.g., audience sentiment, song interpretations, historical influences, and future purchase tendencies), which may be aggregated into a story.

Data may be referred to as “raw information” that can originate in any format, such as a recorded song, song lyrics, album art, promotional images, interviews, or a combination thereof. Information is any data that can be collected, formatted, digitized, produced, distributed, understood, deployed, and transmitted to the user/viewer/receiver in a comprehensible form. In some examples, information is associated with song lyrics, artist narratives, live concert stories, album artwork, and multi-media and organization of information or data may be associated such that the information and/or data may be aggregated into one or more stories.

When information is entered into and stored in an electronic database, it is generally referred to as data. After undergoing processing and retrieval techniques (e.g., associating attributes, characteristics, qualities, traits, elements, descriptors, and other associated data formatting) output data can then be perceived as useable information and applied to enhance understanding of something or to do something. Examples of the systems and methods described herein may relate to information as elements of a story or a story itself which may be an aggregation of information.

Data processing can take place within a framework or system, divided into three distinct stages. First, data is collected, gathered, and/or input from various sources, such as recording studios, live performances, interviews, social media, and individuals. Second, data is sorted, organized, cleansed, and input into a digital repository, database, or system. Third, data is transformed into a suitable format that users can understand and use. Quality data can be required for transformation into quality information. For instance, quality data must come from a reliable source (e.g., quality consistently exceeds a threshold), be complete without missing details, have systems in place to eliminate duplicated data, add relevance and value to the database to generate meaningful information, and be current and timely. Examples of the systems and methods described herein can integrate multiple data types, quality information, retrieval requirements, and associated technologies and processes.

Examples of the present technology may relate to information as elements of a story or a story itself which may be an aggregation of information. When information is entered into and stored in an electronic database, it is generally referred to as data. In some examples, this technology can integrate multiple data types, determine quality of the data, and format the data. For example, using the systems and methods discussed herein, a system can utilize various data search view techniques in its system framework to access data and transform it into usable information. These include a holistic or comprehensive view, which refers to the complete data set “picture.” This view looks at the data throughout its entire lifecycle-from the moment an object originates until the information is needed by a music enthusiast at the current moment of retrieval. An example of such a holistic view may outline a story, including data elements from multiple data sources, aggregated according to a common subject, theme, or query.

The holistic data approach is designed to improve data analysis and integration by enabling information to be distributed across multiple platforms and systems efficiently and consistently. The first component of the holistic data process includes data collection-assembling information from a variety of public and/or private sources. Data collection can be compiled and identified from structured, semi-structured, and unstructured sources, for example operational systems (e.g., CRM, financial systems), website information, on premise data, internet of things (IoT), artificial intelligence (AI), machine learning (ML) models, large language models (LLMs), social media, and user-supplied narratives and/or stories.

The second component includes the integration and transformation of data related to music recordings, merging disparate data from numerous sources, such as personnel, equipment, events, locations, and musical concepts, into a readily accessible and user-friendly database(s). These consolidated data assets allow seamless access by end-users. Ensuring data quality, consistency, and control is vital for the data integration and transformation process. An SIO system offers processes that are repeatable, automated, and scalable to meet future demands in the music industry.

The third component involves presenting holistic data in a meaningful format(s) when requested, maintaining and supplementing data within a structured framework, increasing in value over time remains a source of evolving relevant to users. Presentation techniques can highlight key metrics, trends, multiple value types, and exceptions and offer customized and unique visualizations. The SIO system can present data in the form of a narrative or story, forming a comprehensive musical record which may include transcript(s), image(s), timeline(s), video(s), and/or audio.

The fourth component centers on maintaining data quality and consistency, which is crucial for the long-term viability of the holistic musical data. An SIO system as discussed herein can deploy tactics including identifying data quality thresholds, fraud alerts, audit report functionality, and robust data governance protocols. In some examples, all SIO master data repositories and data privacy strategies applies to all users. In some examples, data quality may include a system and/or method of verifying the accuracy or truthfulness of musical data.

In some examples, the technologies discussed herein provide personalized experiences for the user, offering a revolutionary future for data visualization. Unlike systems in which questions are asked and answers are found, a humanistic view of data can be contextual and/or related to specific musical recordings, events, or relationships. Data views are transformed into visual representations, adding substance and context to the experience, for instance via creation of musical narratives.

The SIO systems disclosed herein leverage information from individuals with a personal connection, or interest in specific music recordings, events, and/or cultures. An SIO system can implement a personalized approach to how data associated with music is captured, analyzed, and displayed, acknowledging that subjectivity and context can play a pivotal role in understanding musical objects, events, social changes, and culture. The SIO systems analyze received data to understand the values and needs of people in the larger context of their lives (e.g., the aggregation of musical data forming a narrative or story).

In some examples, this technology can integrate and use chronological and/or historical data views, timelines, and processes for music recording attribution. Chronological, historical, or timeline view data, broadly considered, is collected about past events and circumstances related to a specific music recording, object, information set, or subject matter. Historical data includes most data generated manually or automatically and tracks data that changes or is added over time. Historical data offers a broad range of use possibilities relating to music recordings, narratives, stories, concepts, procedures, empirical data, and/or music recording information. Examples of the present technology relate to chronological data via improvements in the collection and aggregation of such data, including data that otherwise may not intuitively be associated with a chronological context and provide the data as a story, adding context to a chronological sequence of music events.

With increased cloud computing and storage capacities, data collection and retrieval allow for more data related to music recordings stored for greater periods with access by more users. Since data storage does require resources and maintenance, data life cycle management (DLM) can ensure that rarely referenced data can be archived and accessed only when needed.

In some examples, this technology can integrate clustered view data in music recording attribution. Data clusters show which data points are closely related, so the data set can be structured, retrieved, analyzed, and understood more easily. Examples of the present technology may leverage data clustering to form association which may be used to aggregate data to form stories. Data clusters are a subset of a larger music dataset in which each data point is closer to the cluster center than to other cluster centers in the dataset. Cluster “closeness” is determined by a process called cluster analysis. Data clusters can be complex or simple based on the number of variables in the group. Data clustering can be performed using a clustering algorithm, such as centroid-based clustering, distribution-based clustering, hierarchical clustering, K-means clustering, DB scan clustering, Gaussian mixture modeling, balance iterative reducing and clustering using hierarchies (BIRCH), affinity propagation clustering, means-shift clustering, ordering points to identify the clustering structure (OPTICS), agglomerative hierarchy clustering, or a combination thereof.

Clustered data sets occur in abundance because all the events we experience and that we may wish to identify, understand, associate with specific music recordings and act upon have measurable durations and locations. It, therefore, follows that the individual data points associated with each instance of such an event are clustered with respect to time and space. Many events associated with clustered data can be highly significant, and it is important to identify them as accurately as possible. Clustering is deployed for high-performance computing. Since related data is stored together, the related data can be accessed more efficiently. Cluster views deliver two advantages: efficiency of information retrieval and reducing the amount of space required for digital storage. Information related and frequently requested can be used for cluster viewed data requirements.

In some examples, the present technology can integrate multiple data visual formats. Data visualization is a methodology by which the data in raw format is portrayed to reveal a better understanding and provide a meaningful way of showcasing volumes of data and information. Various methods of data visualization and viewing options can be deployed for various purposes and information sets, including supply chain views. For example, in supply chain, there is a need to create data visualizations that capture the connectedness of music objects through time and space in relation to variables such as materials, timelines, locations, involved companies, and individuals. For instance, the system may display a view showing layers of relationships of music objects in a grid or other rich digital media display. This process can form narratives comprised of aggregated data or information for the user.

A clear understanding of the audience influences the visualization format types and creates a tangible connection with the listener. Every data visualization formats and narratives may be different, and visualization types may be customized based on goals, aims, objects, or topics. Examples of the present technology may relate to the audience as a perspective, or an element of the perspective which may influence or direct the information aggregated to create a music story.

In some examples, this technology can integrate hierarchical database models, technologies, and processes. A hierarchical data view is defined as a set of data items related to each other by categorized relationships and linked to each other in parent-child relationships in an overall “family tree” structure. When information needs to be retrieved, the whole tree is scanned from the root node down. Modern databases have evolved to include the usage of multiple hierarchies over the same music data for faster, easier searching and retrieval. Embodiments of the present technology may relate to hierarchical data by improvements in the methods of aggregating data to form music stories which may be illustrated in a hierarchical form.

The hierarchical structure of data is important as the process of data input, processing, retrieval, and maintenance is an essential consideration. An example would include a catalog of music recordings, each within specific categories. Categories could be high-level categories such as genre, artist, year, and recording equipment-however, there may also contain subcategories within those: in genre, there may be jazz, rock, classical-artists can include famous musicians, emerging artists, and bands. Within subcategories, there may be even more categories and so on.

The hierarchical database model offers several advantages, including but not limited to the ability to easily add and delete new information, data at the top of the hierarchy being quickly accessible via explicit table structures, efficiency for linear music data storage applications, support for systems that work through a one-to-many relationship, efficiency in storage and retrieval model for large music data sets, improved music data sharing, and a clear chain of authority and security.

In some examples, this technology can integrate spherical music data views and music data credibility control. A spherical data view is a form of non-linear data in which observational data are modeled by a non-linear combination model relying on one or more independent variables. Non-linear methods typically involve applying some type of transformation to the input music dataset. After the transformation, many techniques can then be tried to use a linear method for classification.

Data credibility is a major focus implemented to ensure that music databases function properly and return quality music data and accurate information to the user. In some examples of an SIO system, a weighted average technique of ensuring data quality can be utilized and includes processing a collection of each of the music data attributes such as location, type of device, history, individual, current, and past relationships with other SIOs, and many others to determine the credibility of the SIO music data. For example, a search for a song recorded in a certain location by a specific artist can include information relating to recording equipment, song genre, artist name, recording studio, date, compliance with regulations, and copyright information. This process evaluates the average of a music data set, recognizing (e.g., weighing) certain information as more important than others.

Verifying music data integrity is an extremely important measure since it establishes a level of trust a user can assign to the information returned and presented. Credible music data can be assured when robust music data management and governance are incorporated into the system. Satisfying the requirements of intended users and associated applications improves the quality of the music data by assuring the highest quality is kept, including but not limited to accuracy from music data input through music data presentation, exceptional database design and definition to avoid duplicate music data and source verification, music data governance and control, accurate music data modeling and auditing, enforcement of music data integrity, integration of music data lineage and traceability, quality assurance and control, or a combination thereof.

In some examples, this technology can integrate computer programming and blockchain technologies. A blockchain framework provides a unique data structure in the context of computer programming, consisting of a network of databases/virtual servers connected via many distinct user devices. Whenever a contributor in a blockchain adds data (e.g., a transaction, record, text, or a combination thereof), it creates a new “block,” which is stored sequentially, thereby creating the “chain.” Blockchain technology enables each device to verify every modification of the blockchain, becoming part of the database and creating an exceptionally strong verification process. Examples of the present technology may relate to blockchain frameworks wherein music data may be stored as blocks within a blockchain, or a music story or query used to generate a music story, may comprise a block or series of blocks in a blockchain.

Security provided by this distributed ledger/music data process is among the most powerful features of blockchain technology. Since each device holds a copy of these ledgers, the system is extremely difficult to hack-if an altered block is submitted on the chain, the hash or the keys along the chain are changed. The blockchain provides a secure environment for sharing music data and is increasingly used in many industries, including music, entertainment, and media.

Blockchain ledgers are typically divided into three distinct types and can be managed differently by the network participants. For instance, blockchain ledger implementations can include (1) public blockchain ledgers, (2) private blockchain ledgers, and (3) hybrid blockchain ledgers. Public blockchain ledgers are open to a wide range of users where anyone can join a network and are by design “decentralized systems” where participants can read, add entries, and participate in processes. Public blockchains are not controlled by any one party. Private blockchains are open to a limited number of people and are typically used in a business environment where the content in the blockchain is not shared with the public and can be controlled by one or more parties. A hybrid blockchain implementation is a mixture of private and public blockchains that, in some examples, is not open to everyone but still offers music data integrity, transparency, and security features that are novel components of the technology. Blockchain technologies offer increased security and can accommodate highly scalable applications.

In some examples, this technology can integrate non-fungible tokens (NFT). Blockchain security and cryptographic protocols make this technology increasingly attractive for business models and applications where provenance and authenticity are critical. While blockchain is well-known for applications in the cryptocurrency world, it is becoming an essential component of applications for NFTs.

If something is fungible—it is interchangeable with an identical item-NFTs, on the other hand, are unique and non-interchangeable units of music data stored on a blockchain—therefore, one NFT is not equal to another. The possibilities for NFTs within the blockchain framework are virtually endless because each NFT is unique yet can evolve over time. The value of NFTs is in their “uniqueness” and ability to represent physical objects in the digital world. Examples of the present technology may relate to the creation, recording, preservation, sale, or exchange of music data NFTs.

Once an NFT is created for a music recording, it is assigned a unique identifier on the chain it is created on that assures authenticity and originality on that blockchain. Each NET is unique on the chain it is minted on, so all the information (such as the artist's name, song's title, album details, and recording studio) about the token is stored on the instantiated “mined on” blockchain-meaning if one “block” in the chain fails, information still exists on another block, ensuring the NFT remains safe and secure indefinitely.

The unique capabilities of blockchain technology coupled with NFTs guarantee the authenticity, originality, and longevity of music recordings. With blockchain technology, it is impossible to copy or reproduce an NFT, and ownership of a music recording is recorded in an unalterable way (or a way in which alteration(s) are detectable).

In some examples, NFTs can represent a specific recording, a concert's digital artifact, or a record of music data attribution, including personnel, equipment, events, locations, and musical concepts. In another example, NFTs are not limited to purely digital items, but digital versions of physical items like vinyl records can be attached to specific narratives and stories. Unlike digital media, represented by codes and numbers—physical objects are separate entities that can carry intuitive connections.

Memories related to music recordings can be tied to both physical objects like vinyl records or concert tickets and digital data, such as song files or playlists. For instance, a specific album may evoke narrative memories of a particular period in a listener's life that is associated with the music recording. In some examples, narratives can be associated with a producer's notes passed from one recording session to the next or a ticket stub from a concert.

An example of this technology is occurring in the preservation of musical heritage. Collecting and preserving music data, objects, and associated narratives allows communities to interact with historically and culturally relevant music artifacts and objects in unique and novel ways. These objects communicate with the listener through the memories we associate with them. Global music events and objects are inextricably linked to personal histories. Examples of the present technology relate to musical heritage preservation by improving the aggregation of data from a plurality of data sources relating to music recordings, artists, recording equipment, musical events, locations, and other related factors to form stories with improved context. The context may further be improved using systems and methods to quantify and account for the reliability, accuracy, and authenticity of data and data sources.

Some illustrative and non-limiting example embodiments of this disclosure, illustrating its features, are discussed in detail with respect to the figures.

It can be noted that as used herein and in the appended claims, the singular forms “a,” “an,” and “the” include plural references unless the context clearly dictates otherwise. Although any systems and methods similar or equivalent to those described herein can be used in the practice or testing of embodiments, only some exemplary systems and methods are now described.

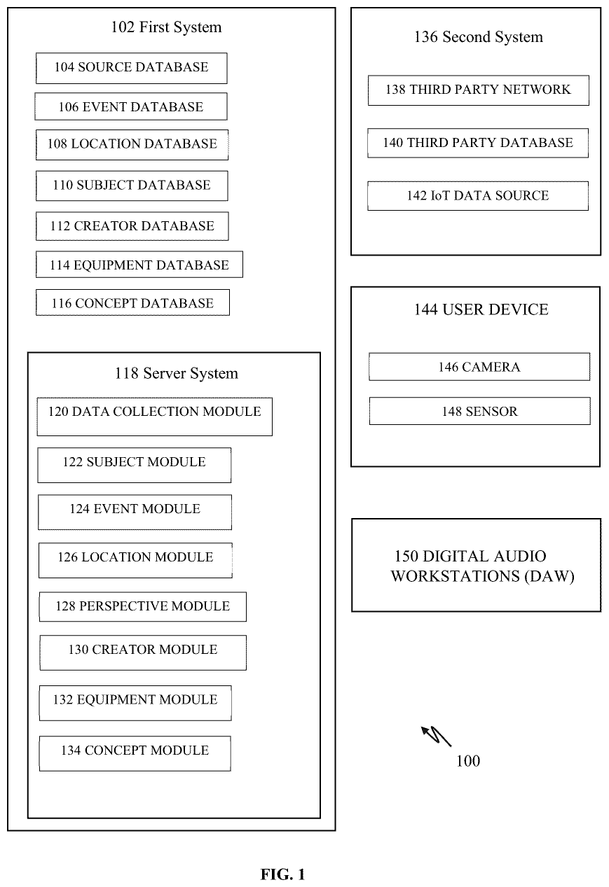

FIG. 1 is a block diagram illustrating an architecture of a media attribution system 100, according to some examples. The media attribution system 100 is a system that can extract, analyze, organize, store a large amount of content related to music recordings. The media attribution system 100 consists of building blocks, which are objects with rich data attributes such as events, characters, locations, creator, equipment, concepts, or a combination thereof. These objects may be created and edited by users or automatically by modules. The media attribution system 100 also includes references to source materials stored in a source database, which may be, for example, audio and music recordings, audio books, events, recording sessions, live performances, or a combination thereof. These sources are used to create and support the building blocks, allowing users to see where the information originated and how it is continuously related to other objects.

This media attribution system 100 comprises a first system 102 that may collect, create, and store SIO's and code for instantiated and analyzed objects. The first system 102 enables instantiation of SIO data for each object in the media attribution system 100, and associates and recommends data based on time, place, written tags, descriptions, commonality, and emotions to be displayed through an interface, among other defining attributes and functions. The first system 102 may further be used to assess and verify the accuracy of an object or story which may be comprised of one or more objects. Truth may be based upon verifiable facts, or by corroborating one or more objects with one or more similar or verifiable accounts. For example, a plurality of accounts may describe the series of events during a musical concert. While the perspectives of each account may vary, some common elements can be corroborated such as the singers and instrumentalists, the location and time of the musical concert, the theme of the musical concert, the songs which were played during the musical concert, or a combination thereof. Verifying common details may provide confidence that the source of the data is trustworthy and therefore their account may be trusted. By contrast, if elements of an individual's account conflicts with the majority of other accounts, then the individual, or their account of the event, may be deemed less trustworthy, and therefore their story may not be trusted. The first system 102 may additionally aggregate data, such as data about recording studios, and upon selection of one or more parameters, may generate a story comprised of one or more relevant accounts of subjects, events, and/or locations which may then be structured, such as in the chronological order of events, or as locations and/or features as a map, before being presented to a user.

Source database 104 stores data relating to sources of data, and particularly includes an indication of the trustworthiness or reliability of the source. A source may refer to an individual providing one or more narratives such as via oral dictation, uploading a recording, providing a written dictation, or live recordings. A source may also refer to a specific musical instrument's name, an artist's name, a publishing entity, corporate body, or any other organization. A source may additionally refer to third-party networks 138, third-party databases 140, and IoT data sources 142. In some examples, a source may be associated, initiated on or instantiated by a website such as Wikipedia. In another example, a source may refer to a user device 144, a camera 146, a sensor 148 (may include a microphone used to record music), or a digital audio workstation (DAW) 150. In some examples, a source may specifically refer to record labels, performance rights organizations, a music company, recording studio, or live music venue, a particular FM broadcasting station. The trustworthiness or reliability metric may be represented by a binary ‘trustworthy’ or ‘untrustworthy’ data type or may alternatively be represented by a qualitative range of values such as ‘trustworthy,’ ‘somewhat trustworthy,’ ‘unknown trustworthiness,’ ‘somewhat untrustworthy,’ or ‘untrustworthy.’ Similarly, trustworthiness or reliability may be represented by a quantitative value, such as a score. The score may represent a probability that the source can be trusted, which may be interpreted as the likelihood that the source is accurately describing the truth. A quantitative measure may alternatively utilize a regressive method to adjust the source's reliability score based upon each accurate or inaccurate contribution which may comprise any of narratives, objects, object characteristics, or a combination thereof. Source reliability additionally be impacted by credentials, such as whether a source is deemed a specialist in a given field. Additionally, the amount of reliability score is adjusted may be impacted by the degree to which the source's contribution is inaccurate or the relative reliability scores of corroborating sources and data. The source database 104 may be populated by a trust verification system. The source database 104 may be used by the server system 118, data collection module 120, subject module 122, event module 124, location module 126, and may further be utilized by one or more optional modules such as creator module 130, equipment module 132, and concept module 134.

The event database 106 stores data related to time-related events related to music or data comprising time-based data such as one or more dates, times, year of publishing music and may additionally include descriptions and/or characteristics of the music that was released at a specific date and/or time. The resolution of event data in respect to time may vary. For example, an event may reference a time accurate to a second or a fraction of a second, or may reference a specific minute, hour, day, week, month, year, or span of multiple years. For example, an event may describe a live concert of “Sunburn,” which may be, for example, a multiday music festival comprising a plurality of musical acts, with an event ID 1684, which occurred on Jun. 6, 2018. Alternatively, an event may describe the live concert of “Sunburn”, which could be referenced as occurring between 2016 and 2020 or may more precisely be referenced as occurring between Sep. 1, 2016, and Sep. 2, 2018. Event data from one source may be associated with data from a plurality of other sources. Associated data may not match exactly. For example, if a first source with an event ID 2241, referred to live concert of “Sunburn” as occurring between 2015 and 2018, while a second source with an event ID 891 referred to live concert of “Sunburn” as occurring between Sep. 1, 2015, and Sep. 2, 2018, the two references would be associated as they are both true, though they use different resolutions of time-based data as they both accurately describe the live event of “Sunburn”. The event database 106 may be populated by a data collection module 120 and is updated by an event module 124. The event database 106 may additionally be populated by one or more of a second system 136, third party network 138, third party database 140, IoT data source 142, user device 144, camera 146, or one or more sensors 148. The event database 106 is utilized by the event module 124 and the perspective module 128. The second system may be implemented in cloud.

In some examples, NFT associated with the event may be sold. Each day of the event may also be issued with an NFT, where each NFT may be allotted with a unique token code and assigned token value. For example, the live concert of “Sunburn” held on Jun. 6, 2018 is given a token code SN096 and has a token value $90,000. In another example, the token value may be established by market transactions on an NFT market after the token has been issued. The token code SN096 and token value $90,000 may be linked to event ID 1684.

In some examples, the NFT may convey certain rights with regard to broadcast and distribution of the digital recordings associated with the event. For example, using the event ID, a user may purchase the rights of the live concert to able to telecast on air by purchasing the NFT.

The location database 108 stores data related to location related data such as a continent, country, state, city, town, street, address, building, or a combination thereof. Location related data may also comprise GPS coordinates, regions, including common names, as well as geographic features, such as mountains, valleys, canyons, rivers, streams, lakes, oceans, or a combination thereof. For example, a location may be a length of coastline called Cassis beach in France, where a live music event of “Sunburn” was held. In some examples, the geographic location may change based on the passage of time. For example, New York City was known as New Amsterdam until 1665, when the British seized control over the Dutch. Location from one source may be associated with location data from other sources. Associated data may not match exactly. For example, Cassis beach may be associated with Paris, France. Likewise, France may be associated with Europe. Other examples may comprise Wall Street in Manhattan, New York. Likewise, Manhattan, New York may be associated with New York City, New York. New York City may also be referred to as the Big Apple, and was historically known as New Amsterdam, therefore such references may be associated. Likewise, a participant of a live music event may use the coordinates associated with the location the event is being held to navigate towards the location based on the event ID with map based applications such as Google maps or Apple maps. In some examples, the event ID may allow a system to integrate with third-party systems to coordinate parking, lodging, vendors, and other location-specific services associated with the event, or a combination thereof. The location database 108 may additionally be populated by one or more of a second system 136, third party network 138, third party database 140, IoT data source 142, user device 144, camera 146, or one or more sensors 148. The location database 108 is utilized by the location module 126 and the perspective module 128.

The subject database 110 stores data related to subjects, which may be people participating in, for example, a music event, in a song, or a combination thereof. In some examples, the subject database 110 stores data primarily related to people related to music recording. The subject data may relate to specific people, or groups of people involved in a music event or people behind the creation of a music. Groups of people may be referenced directly or may comprise an aggregation of data about people belonging to or who can be associated with the group. For each subject, the subject database 110 may store a numerical value for the subject ID, a numerical value for the source ID received from the source database 104, and a description of the subject, such as a name of a music album, an instrument played on the music album, or a job title of people behind the creation of a music. For example, a U.S. instrumentalist Ross having Subject ID 654981 and Source ID 6541, may be associated with a music album called “Rock n Roll” on which he played an instrument, such as a guitar, bass, drums, or a combination thereof. In another example, Jack having Subject ID 132146 and Source ID 1464, may be associated with a music album called “Rock n Roll” on which he was an audio technician.

The creator database 112 stores data related to people, companies or organizations that have contributed to the creation of music in one or the other form. In some examples, the people, companies, or organizations contributed may be linked to a unique set of an SIO object ID and a creator ID that associate them with a music album. For example, Alex, Martin and Matthew are the people involved in creating an album of music called “Fire”. Alex, having an SIO object ID X39CE2 and creator ID MIC089, is the lyricist of the songs on the album, Martin having an SIO object ID X39CE3 and creator ID MIC090 is the composer. In another example having a recording studio where the album was recorded, mixed, and mastered, the SIO for the album may provide a list of personnel associated with the album, including listing the recording engineer as Stuart, the mix engineer also as Stuart, a master engineer also as Jacob, various technicians such as Ross and Smith, a creative contributor as Rowen, and an artist manager Jonas. Thereby, each of the creators are given their unique SIO object ID and a creator ID that associates them with the “Fire” album.

The equipment database 114 stores data related to instruments, hardware and software equipment, acoustic treatments, and other equipment that are used for or involved with creating a music recording. In some examples, the equipment database 114 stores names of the instruments used in the music recording. Examples of the names may be the instruments' maker, model, year, specifications, or a combination thereof. In some examples, the equipment data may further be linked to a specific SIO object ID. For example, an SIO object ID may be linked to equipment, to an artist playing a specific instrument, to a recording engineer using a specific microphone, cable, console, or a combination thereof. In another example, the equipment data may relate to specific sets of instruments played in a musical concert of an individual instrument played in a small music sample.

The equipment database 114 may also store music recording equipment such as microphones, cables, outboard gears, inboard gears, and storage for the recorded music. For example, a music sample of time stamp 30 seconds can be associated with an instrument played, such as electric guitar by Alex which may be a 1969 Fender Stratocaster plugged into a Marshall JCM8000, which was recorded by using an active condenser-type Neumann microphone, and Mogami brand instrument cables used to plug in the electric guitar into the amplifier. The music sample can also be associated with an equalizer used as an outboard gear module along with an audio interface, various digital plugins to the DAW 150, and digital type storage used to store the recorded music piece from the electric guitar. In some examples, the equipment used may be given a unique SIO object ID R09ACO. In another example, Ross is a music composer and wants to create music by using DAW 150. Ross wants to merge the sounds of a few instruments which he wishes to use in a final product. Thereby, Ross can integrate an acoustic guitar by using SIO object ID as R09AC10, keyboards by using SIO object ID as R09AC12 and a bass guitar by using SIO object ID as R09AC11.

The equipment database 114 may also store different specifications for each of the instrument. For example, different specifications include model, manufacturer, and configuration. In an example where the instrument is a guitar, the specifications may be the tuning of the guitar, types of strings, pickups or other physical modifications to the guitar, or a combination thereof, with each given a unique SIO object ID. Different instruments may also be stored in the equipment database 114 with their corresponding specifications. The instruments with corresponding specifications may include drum kits, keyboards, microphones, amplifiers, effects pedals, preamps, equalizers, compressors, audio interfaces, MIDI Controllers, headphones, studio monitors, mixing consoles, DAWs, audio plugins, DJ equipment, MIDI Sequencers, sound modules, wind instruments, string instruments, percussion instruments, microphone stands, acoustic treatments, DI boxes, patch bays, cables, power conditioners, audio racks, pedalboards, guitar strings, drumsticks, violin bows, saxophone reeds, microphone pop filters, microphone shock mounts, power amplifiers, direct boxes, electronic drums, drum machines, samplers, loop stations, master clocks, outboard gear, MIDI interfaces, synthesizers, wireless systems, pedal power supplies, noise gates, tuners, guitar picks, instrument cases, studio furniture, rackmount cases, audio converters, audio recorders, guitar capos, music stands, metronomes, banjos, ukuleles, harmonicas, audio crossovers, microphone Preamps, Limiters, audio mixers, phono preamps, record players, mandolins, music software, electronic tuners, talkboxes, theremins, keyboard stands, guitar slides, violin rosins, keyboard pedals, drum pedals, sheet musics, vocal processors, stage lightings, fog machines, video projectors, music production controllers, multitrack recorders, drumheads, portable PA systems, audio patchbays, guitar straps, violin strings, MIDI cables, studio subwoofers, wireless microphone systems, guitar wireless systems, instrument microphones, overhead microphones, feedback suppressors, or a combination thereof, as well as any other type of equipment that may be used in the future.

The instruments with corresponding specification may include different components. For example, drum kits may include snare drums, bass drums, toms, hi-hats, cymbals, or a combination thereof. Keyboards may include digital pianos, synthesizers, organs, or a combination thereof. Microphones may include dynamic, condenser, ribbon, lavalier, or a combination thereof. Amplifiers may include guitar amps, bass amps, keyboard amps, or a combination thereof. Effects pedals may include overdrive, distortion, fuzz, delay, reverb, chorus, or a combination thereof. Preamps may include different models and configurations. Equalizers may include different models, manufacturers, and types, such as graphic, parametric, or a combination thereof. Audio Interfaces may include different models, manufacturers, and input/output configurations. MIDI Controllers may include different models, manufacturers, and types, such as keyboard, drum pad, or a combination thereof. Headphones may include different models, manufacturers, and types, such as over-car, in-car, or a combination thereof. Studio monitors may include different models, manufacturers, and sizes. Mixing Consoles may include different models, manufacturers, and channel counts. DAWs 150 may include software such as Pro Tools, Logic Pro, Ableton Live, or a combination thereof. Audio Plugins may include different types such as virtual instruments, effects, mixing and mastering tools, or a combination thereof., DJ equipment may include turntables, mixers, DJ controllers, or a combination thereof. Sound Modules may include different models, manufacturers, and types. Wind instruments may include different types such as saxophones, flutes, trumpets, or a combination thereof, String instruments may include different types such as violins, cellos, double basses, or a combination thereof. Percussion instruments may include different types such as congas, bongos, tambourines, or a combination thereof. Microphone stands may include different types and models. Acoustic treatments may include different types such as diffusers, bass traps, or a combination thereof. Cables may include different types such as XLR, TRS, RCA, or a combination thereof. Audio racks may include different models, manufacturers, and sizes. Pedalboards may include different models, manufacturers, and sizes. Guitar strings may include different manufacturers, types, and gauges. Drumsticks may include different types, sizes, and manufacturers. Violin bows may include different types and manufacturers. Saxophone reeds may include different manufacturers and strengths. Power amplifiers may include different models, manufacturers, and power ratings. Direct boxes may include different models, manufacturers, and types, such as passive and active types. Electronic drums may include different models, manufacturers, and configurations. Samplers may include different models, manufacturers, and types, such as hardware and software types. Outboard Gear may include different models and manufacturers of reverb units, delay units, or a combination thereof. Synthesizers may include different models, manufacturers, and types, such as analog, digital, and hybrid. Wireless system may include Different models, manufacturers, and types pertaining to instrument, and microphone. Tuners may include different models, manufacturers, and types pertaining to a pedal, a rack, a clip-on. Guitar picks may include different types, sizes, and materials. Instrument cases may include different models, manufacturers, and types, such as hard or soft. Studio furniture may include different types such as chairs, desks, stands, or a combination thereof. Rackmount cases may include different models, manufacturers, and sizes. Audio converters may include different models, manufacturers, and types such as A/D or D/A. Audio recorders may include different models, manufacturers, and types such as field or studio. Guitar capos may include different models, manufacturers, and types. Metronomes may include different models, manufacturers, and types such as mechanical or digital. Harmonicas may include different models, manufacturers, and keys. Audio crossovers may include different models, manufacturers, and types such as analog or digital. Audio mixers may include different models, manufacturers, and channel counts. Music software may include Notation software, virtual instrument libraries, or a combination thereof. Guitar slides may include different types and materials. Violin rosins may include different manufacturers and types. Keyboard pedals may include different models, manufacturers, and types such as sustain or expression. Sheet Musics may include different pieces, composers, and arrangements. Stage lighting may include different models, manufacturers, and types such as LEDs, par cans, or moving heads. Video projectors may include different models, manufacturers, and types. Multitrack recorders may include different models, manufacturers, and track counts. Drumheads may include different models, manufacturers, and types such as single-ply or double-ply. Guitar straps may include different models, manufacturers, and materials. Violin strings may include different models, manufacturers, and types such as gut, steel, or synthetic. MIDI cables may include different models, manufacturers, and lengths. Studio subwoofers may include different models, manufacturers, and sizes. Wireless microphone systems may include different models, manufacturers, and frequency bands. Instrument Microphones may include different models, manufacturers, and types such as clip-ons or goosenecks.

Concept database 116 stores data related to subjects, which may be related to concepts used in a musical piece or audio recording. In some examples, the concept database 116 stores data primarily related to various musical concepts used for creating music. Concepts may include a variety of terms, tools, ideas, expressions used in the description, analysis, conception of a musical composition, phrase, idea. In some examples, concepts may include pitch, rhythm, tempo, timbre, melody, harmony, dynamics, form, key/scale, expression, tradition, genres, musical key, or a combination thereof.

In some examples, the concepts may also include harmonic structures (e.g, use of specific chords or harmonic progressions), rhythmic patterns (e.g., syncopation, polyrhythms, or a combination thereof), orchestration (e.g., specific combination of instruments used), dynamics (e.g., changes in volume or intensity), modulation (e.g., key changes within a piece), motifs (e.g., repeated fragments of melody or rhythm), lyrics themes (e.g., subject matter of the song lyrics), instrumentation (e.g., the specific instruments used), sound designs (e.g., use of specific audio effects or processing techniques), song arrangements (e.g., the layout of the different musical parts), vocal techniques (e.g., use of specific singing techniques or styles), performance techniques (e.g., specific ways of playing an instrument or singing), improvisations (e.g., any parts of the song that were spontaneously created), samplings (e.g., use of pre-recorded sounds or music), music production techniques (e.g., use of studio techniques like multi-tracking, equalization, compression, or a combination thereof), counterpoints (e.g., the relationship between two or more melodic lines), syncopations (e.g., placement of rhythmic stresses or accents where they wouldn't normally occur), tones/timbres (e.g., the unique sound quality of a voice or instrument), polyphony (e.g., multiple simultaneous melodic lines), microtonalities (e.g., use of pitches that fall outside the traditional 12-tone scale), aleatoric elements (e.g., any elements of chance or randomness in the music), serialism (e.g., use of series or rows of pitches, rhythms, dynamics, or a combination thereof), augmentations (e.g., increasing the length of the notes in a theme or melody), diminutions (e.g., decreasing the length of the notes in a theme or melody), retrogrades (e.g., reversal of a theme or melody), inversions (e.g., flipping a theme or melody upside down), transpositions (e.g., shifting a theme or melody to a different pitch level), minimalist techniques (e.g., use of repetitive structures and gradual transformation), phasings (e.g., simultaneous performance of the same part at slightly different speeds), drones (e.g., use of sustained or repeated sounds), musical forms (e.g., sonata, rondo, theme and variations, or a combination thereof), use of silences (e.g., incorporation of pauses or moments of silence), aleatoric techniques (e.g., use of elements of chance or randomness in the composition), musical quotations (e.g., direct references to other existing pieces of music), scoring techniques (e.g., the methods used to write music for specific instruments or ensembles), ornaments (e.g., musical flourishes that are not necessary to carry the overall line of the melody or harmony, extended techniques (e.g., unconventional, unorthodox, or non-traditional methods of singing or of playing musical instruments), loops (e.g., repeating sections of sound material), calls and responses (e.g., a succession of two distinct phrases where the second phrase is heard as a direct commentary on or a response to the first), textural changes (e.g., how the musical texture, such as monophonic, homophonic, polyphonic, or heterophonic texture, changes throughout a piece), articulations (e.g., the musical direction performance technique which affects the transition or continuity on a single note, or between multiple notes or sounds), cadences (e.g., a sequence of notes or chords comprising the close of a musical phrase), dissonance and consonance (e.g., the quality of intervals or chords that sound tense and unstable versus those that sound resolved and stable), scales (e.g., specific sets of pitches used in the composition such as major, minor, pentatonic, whole-tone, or a combination thereof), tonal and atonal (e.g., use of tones that lead to a sense of a tonal center, or lack thereof), expression markings (e.g., indications of changes in tempo, volume, or a combination thereof), phrasings (e.g., the way a musician shapes a sequence of notes in a passage of music to allow expression, much like when speaking English), rests (e.g., intervals of silence in pieces of music, marked by symbols indicating the length of the pause), leitmotifs (e.g., a recurrent theme throughout a musical or literary composition, associated with a particular person, idea, or situation), ostinato (e.g., A motif or phrase that persistently repeats in the same musical voice), modes (e.g., types of scales with distinct sonic characteristics, such as the Ionian, Dorian, Phrygian, Lydian, Mixolydian, Acolian and Locrian modes.), glissando/portamento (e.g., glide from one pitch to another), pedal points (e.g., sustained tone, typically in the bass, during which at least one foreign, e.g., dissonant harmony is sounded in the other parts), rubato (e.g., flexible tempo for expressive purposes), vibrato (e.g., a slight fluctuation in pitch used to enhance or intensify a sound), harmonics (e.g., overtones or pitches which are part of the harmonic series above a fundamental note), octave transpositions (e.g., taking a section of music and moving all the notes up or down in pitch by a constant interval, usually an octave), swings (e.g., a kind of rhythm that involves alternately lengthening and shortening the pulse.), blue notes (e.g., notes sung or played at a slightly lower pitch than that of major scale for expressive purposes, typically used in blues music), contrafactums (e.g., a musical composition consisting of a new melody overlaid on a familiar harmonic structure), program music (e.g., music that attempts to musically render an extra-musical narrative), tone rows (e.g., a non-repetitive ordering of a set of pitch-classes, used in twelve-tone technique), algorithmic compositions (e.g., using mathematical procedures to create music), microtimings (e.g., tiny timing deviations contributing to the ‘feel’ or ‘groove’ of music), polyrhythms (e.g., the simultaneous use of two or more conflicting rhythms), hemiola (e.g., a ratio of 3:2 used rhythmically, creating a feeling of syncopation), polytonality (e.g., the simultaneous use of multiple keys in a musical composition), cacophony (e.g., use of discordant and harsh sounds in music), collegno (e.g., string technique where the player hits the strings with the stick of the bow, rather than by drawing the hair of the bow across the strings), enharmonic (e.g., notes, intervals, or keys that sound the same but are written differently), falsetto (e.g., a method of voice production used by male singers to sing notes higher than their normal range), grace notes (e.g., ornamental notes are usually printed smaller to indicate that it is melodically and harmonically nonessential), harmonic progressions (e.g., the sequence of individual chords, or harmonic changes in a piece), marcato (e.g., playing a note or chord distinctly and louder than surrounding music), non-retrogradable rhythms (e.g., a rhythm which is the same as played forward or backward), pizzicato (e.g., plucking the strings of a string instrument rather than using the bow), solfege (e.g., a system used for teaching sight-singing with do, re, mi, or a combination thereof), and walking bass (e.g., A style of bass accompaniment or line, common in Baroque music and jazz, which creates a feeling of regular quarter note movement).

The server system 118 may comprise the sub-modules including the data collection module 120, the subject module 122, the event module 124, the location module 126, the perspective module 128, the creator module 130, the equipment module 132, and the concept module 134. These distinctive modules, or sub-modules, are operated by the server system to generate a comprehensive understanding of the creation and interpretation of the media content by receiving, collecting, and generating media content data elements. For example, in a case where the media content is a song, “Symphony of Stars” by The Astrals, each module performs its respective function and compiles the amassed data systematically into the respective databases. Such a compilation structures the raw data into coherent repositories, thereby augmenting the accuracy and validation process.

The data collection module 120 analyzes the received media content from the server system 118 to identify one or more data elements from the received media content and queries a source database 104 for a source reliability score, or for data that facilitates determination of a source reliability score. The received media content, the identified data elements, and source reliability score(s) are then saved by each of the subject module 122, event module 124, and the location module 126 depending on the relevance of the identified data elements to each of the databases. In some examples, the identified data elements may additionally be saved by one or more optional modules such as a creator module 130, an equipment module 132, or a concept module 134. The identified data elements are then sent to the server system 118.

The data collection module 120 may query the source database 104 to determine a source reliability score. In some embodiments, the event data may be saved to the event database 106 and the location data may be saved to the location database 108 and the subject data may be saved to the subject database 110. The saved event data, location data, and subject data may additionally be accompanied by a source reliability score.

The subject module 122 is initiated by the server system 118 from which it receives a data clement and queries a subject database 110. A subject similar to the received data element is selected and the received data element and the selected subject data are compared to determine whether they match.

The event module 124 is initiated by the server system 118 from which it receives a data element and queries an event database 106. An event similar to the received data element is selected and the received data element and the selected event data are compared to determine whether they match.

The location module 126 is initiated by the server system 118 from which it receives a data clement and queries a location database 108. A location similar to the received data element is selected and the received data element and the selected location data are compared to determine whether they match.

The perspective module 128 is initiated by the server system 118 and receives one or more perspective parameters describing a desired story to be generated. Each of the event database 106, location database 108, and subject database 110 are queried, in addition to any relevant optional databases and data relevant to the received perspective parameters are selected. Each of the selected data records are arranged chronologically and based upon physical locations.

The optional modules, creator module 130, equipment module 132, and concept module 134, receive a data element, query a relevant database, and compare the data retrieved from the database to the received data element to identify matching or associated data.

The creator module 130 utilizes data related to the singers participating a musical event. The creator data may include the region or country of the singers, the number of people involved, or a combination thereof. Additionally, the creator data may comprise types of singers (e.g., rock genre singers, melody genre singers or a combination thereof). A creator module 130 may, in some examples, be initiated by the server system 118, and may return creator data to the server system 118.

The equipment module 132 utilizes data related to equipment used in the musical event. The equipment data may include guitar, drums, piano, violin, or a combination thereof, used in a musical event. The equipment module 132 may determine which tool was used to create a digital object or asset and allow the verification and registering of the tool or device used to create the digital object into a system for defining and differentiating any digital asset. The equipment module 132 may, in some examples, be initiated by the server system 118, and may return equipment data to the server system 118.

The concept module 134 utilizes data specific to concepts used in a creation of music. The concept data may include musical concepts such as musical key, time signature, tempo, song structure, melodic theme, or a combination thereof. The concept module 134 may, in some examples, be initiated by the server system 118, and may return concept data to the server system 118. In some examples, the concept module 134 may record the method by which the audio content was created. Such as, for example, original, derivative, remix, modification, or a combination thereof.

A second system 136 is a distributed network of computational and data storage resources which may be available via the internet or by a local network. A second system 136 accessible via the internet is generally referred to as a public cloud whereas a second system 136 on a local network is generally referred to as a private cloud. A second system 136 may further be protected by encrypting data and requiring user authentication prior to accessing its resources.

A third party network 138 is comprised of one or more network resources owned by another party. For example, a third party network 138 may refer to a service provider, such as social networks (e.g., Facebook, Instagram, YouTube, Reddit, Snapchat, Twitter/X, LinkedIn, or TikTok), a news website, a publication, a weather provider, or a combination thereof.

A third party database 140 stores data owned by another party. For example, a third party database may store data on a third party network, or may alternative comprise archival data, historical accounts, survey results, customer feedback, social media posts, or a combination thereof. In some examples, a third party database 140 may include, for example, World War II photos from the National Archives.

An IoT (Internet of Things) data source 142 is an internet connected device which may comprise one or more sensors or other sources of data. IoT data sources 142 may comprise appliances, machines, and other devices, often operating independently, which may access data via the internet, a second system 136, or which may provide data to one or more internet connected devices or a second system 136.

A user device 144 is a computing device which may comprise any of a mobile phone, tablet, personal computer, smart glasses, audio, or video recorder, or a combination thereof. In some examples, a user device 144 may include or be comprised of a virtual assistant. In other examples, a user device may comprise one or more cameras 146 and/or sensors 148. A user device may comprise a user interface for receiving data inputs from a user. A camera 146 is an imaging device or sensor 148 which collects an array of light measurements which can be used to create an image. One or more measurements within the array of measurements can represent a pixel. In some examples, multiple measurements are averaged together to determine the value(s) to represent one pixel. In other examples, one measurement may be used to populate multiple pixels. The number of pixels depends on the resolution of the sensor 148, comprising the dimensions of the array of measurements, or the resolution of the resulting image. The resolution of the camera 146 sensor 148 does not need to be the same as the resolution of the resulting image. A camera 146 may be a component in a user device 144 such as a mobile phone, or alternatively may be a standalone device. In some examples, a camera 146 may be analog, where an image is imprinted on a film or other medium instead of measured as an array of light values. A sensor 148 is a measurement device for quantifying at least one physical characteristic such as temperature, acceleration, orientation, sound level, light intensity, force, capacitance, or a combination thereof. A sensor 148 may be integrated into a user device 144, such as an accelerometer in a mobile phone, or may be a standalone device. A sensor 148 may also be found in an IoT data source 142 or a third party network 138. DAWs 150 are musical software used in music production which may comprise any of Pro Tools, Logic Pro, or Ableton Live.

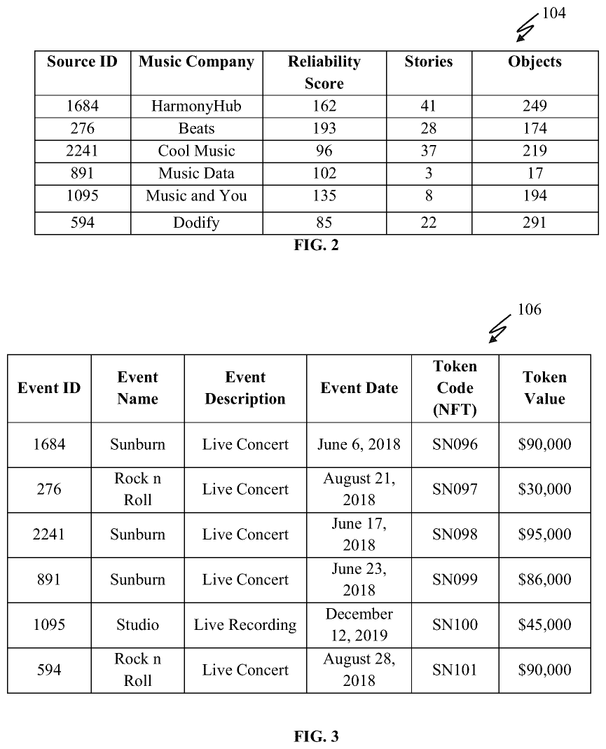

FIG. 2 is a table illustrating exemplary details about different exemplary types of source data, in accordance with some examples. In a source database 104, the exemplary types identified are Source ID, Music Company, Reliability Score, Stories, and Objects. The source database 104 identifies values for these metrics and names for indicating the trustworthiness or reliability of the source.

In some examples, the source database 104 comprises a plurality of source layers, Device ID, ownership of device (e.g., individual or organization), methods of recording (e.g., analog, digital, or some combination thereof), age (e.g., creation date), and movement through time and space (e.g., temporal and geographic location). The reliability of the source may be determined based upon analysis of one or more stories which may be attributed to the source and/or one or more objects which may be attributed to the source. A story is a data record which may be comprised of one or more objects, which are individual data elements. The source database 104 may be populated by a trust verification system. The source database 104 may be used by the server system 118, the data collection module 120, the subject module 122, the event module 124, the location module 126, and may be further utilized by one or more optional modules such as the creator module 130, the equipment module 132, and the concept module 134.

The types of source data in a source database 104 may be utilized to accomplish a particular goal sought by a user. For example, Murphy needs to organize an award show to recognize singers doing well in their carrier. In order to determine the award winner by utilizing an authentic data, Murphy searches for different music platforms that have reactions of people for the singers and the singers' music. Each music platform has a unique Source ID such as 1684, and the Source ID 1684 corresponds to a music platform “HarmonyHub”. Similarly, Source ID 276 corresponds to a music platform “Beats”, and so forth. Additionally, Source ID 1684 has 41 Stories, which is the largest number of stories shown in FIG. 2, and has a Score at 162. Source ID 276 has a Score at 193, which is the highest score shown in FIG. 2. Thereby, Murphy may utilize these scores and metrics corresponding to different music platforms and determine the award winners.

In another example, Alex is a music developer who wants to create a new musical piece with a DAW 150, by integrating the data that correspond to music platforms. Based on the score given to each of the music company, Alex may select the top three music platform having the maximum reliability score. For example, Alex can decide to integrate data of the music platforms “Beats”, “HarmonyHub” and “Music and You” with the DAW 150 since these platforms have the three highest reliability scores as shown in FIG. 2.

A source database 104 may also be used to verify user input data by ascertaining the data's trustworthiness. For example, Fredrick, who recently attended a concert, may provide a review that includes specific details such as the start and end time of the concert, information about the opening act, the setlist, varied elements of the performance, as well as his subjective impressions and emotions associated with the event. Source Database 104 may be used to process Fredrick's review, by verifying the authenticity of Fredrick's concert ticket, confirming that he indeed possessed a valid entry pass to the event. Further, location data linked to Fredrick's account is analyzed to ensure that he was at the correct concert venue at the given date and time. Then, the source database 104 could be used to check Fredrick's music listening history to verify if there exists a consistent pattern of engagement with the artist who performed at the concert. This operation aids in establishing Fredrick's interest in the artist and hence, his potential motivation to attend the concert. Additionally, source database 104 cross-references the accounts of other attendees of the same concert. If other concert-goers corroborate Fredrick's presence, the trustworthiness of his review is solidified. The trustworthiness of Fredrick's review is determined based on such validation.

FIG. 3 is a table illustrating exemplary details about different exemplary types of event data, in accordance with some examples. In an event database 106, the exemplary types identified are Event ID, Event Name, Event Description, Event Date, Token Code (NFT), and Token Value.

In some examples, the event database 106 stores data related to time-based events such as those which comprise a time data reference. Event data may be associated with any significant moment, or any combination of actions in a physical or metaphysical space completed by a human, artificial intelligence (AI), or digital object. In one example, the event data may comprise at least one date and descriptions of one or more events which occurred on that date. The date may additionally comprise a time. The date may instead comprise a year, or a range of years, or alternatively, a date range between two specific dates, weeks, months, times, or a combination thereof. For example, an event comprising a live concert of “Sunburn” with an event ID 1684 can be referenced as occurring on Jun. 6, 2018. The event could be referenced as occurring between 2016 and 2020, or may more precisely be referenced as occurring between Sep. 1, 2016 and Sep. 2, 2018. The event database 106 is populated by a data collection module 120 and is updated by an event module 124. The event database 106 may additionally be populated by one or more of a second system 136, third party network 138, third party database 140, the IoT data source 142, the user device 144, the camera 146, the sensor 148 or the DAW 150. The event database 106 may also be utilized by the event module 124 and the perspective module 128.

In some examples, each of the event may also be issued with an NFT, where each NFT may be allotted with a unique token code and assigned toke value to sell/purchase the rights of events using the NFT issued. For example, the live concert of “Sunburn” held on Jun. 6, 2018, is given a token code SN096 and having a token value $90,000. The token code SN096 and token value $90,000 may be linked to event ID 1684.

In some examples, the event data can be a unique temporal identifier. For example, consider a recording session for a punk rock band, where personal disagreements among the band members resulted in an emotionally charged atmosphere. This conflict consequently infused their recorded songs with a tangible sense of emotional angst, a characteristic reflected in their performances. Event Database 106 archives data related to this emotionally event, which is defined by a unique temporal identifier. The event data may encapsulate details of the recording session, including the date and time it took place, the participation of individual band members, and the emotional context—the interpersonal argument. Recordings captured by IoT data source 142, such as the studio microphones, contribute data to the Event Database 106. These recordings may contain both the musical output and the ambient sounds of the session, potentially providing clues to the emotional context of the event. In addition to the IoT data, eyewitness accounts from individuals present at the recording session, such as the sound engineer or producer, contribute to the richness of the event data. These accounts can provide additional details about the nature of the disagreement and how it affected the band members' performances. Further, subsequent contributions from the band members themselves may provide additional context to the event. These contributions can include interviews, social media posts, or personal anecdotes that reference the recording session and the interpersonal tension present. This data, once verified, can be integrated into the Event Database 106, enhancing the depth and understanding of the event. Moreover, in the event that the band or record company decides to monetize the specific recording session, a Non-Fungible Token (NFT) can be issued corresponding to the event. This unique NFT, associated with a token code and value, may provide rights to the recording session data. For instance, an NFT with a token code ‘PRRS091’, and a token value of $150,000 could be linked to the event ID for this specific recording session. Potential buyers, such as collectors, fans, or broadcasters, could purchase the NFT to gain rights to the unique emotional energy encapsulated within the recording session.

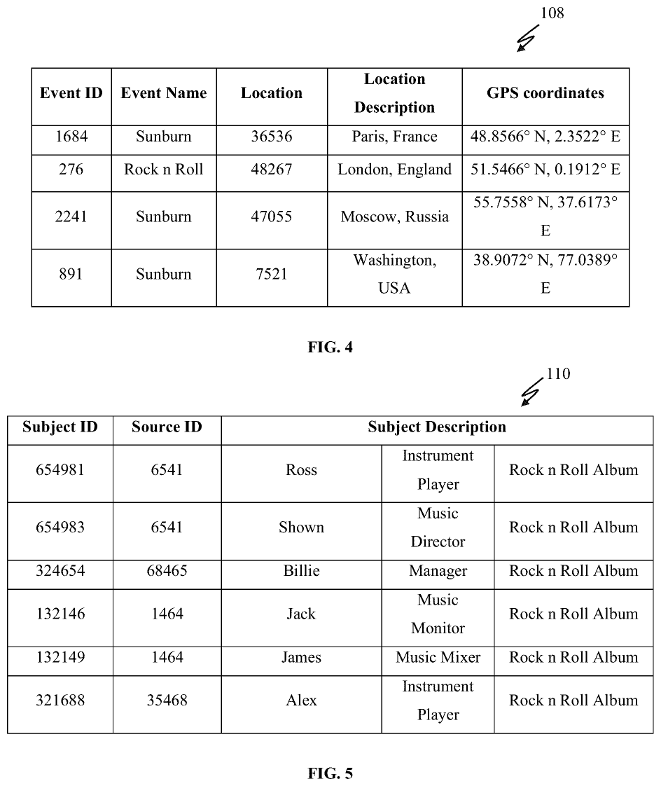

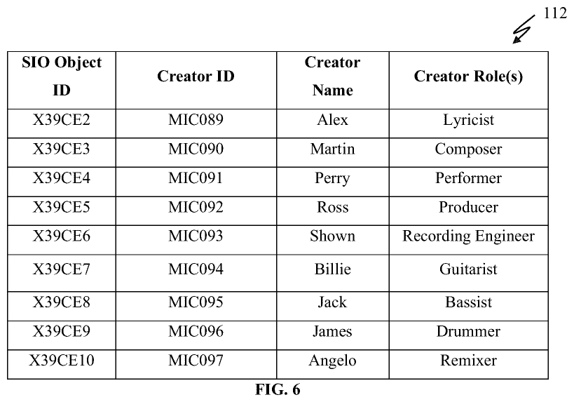

FIG. 4 is a table illustrating exemplary details about different exemplary types of location data, in accordance with some examples. In a location database 108, the exemplary types identified are Event ID, Event Date, Location, Location Description, and GPS coordinates.

The location database 108 stores data related to location, such as locations of live concert, location of a music studio, or a combination thereof. The location data may comprise any of a continent, sub-continent, country, state, city, town, neighborhood, street, address, building, a portion or subset of any of these, or a combination thereof. Location related data may also comprise GPS coordinates, regions, including common names, as well as geographic features, such as mountains, valleys, canyons, rivers, streams, lakes, oceans, or a combination thereof. For example, the coastline of Cassis beach, France, where a live music event of “Sunburn” was organized is a location data. In some examples, the location data may be utilized by a participant in a music event. For example, Alex is a participant in a live music event of “Rock n Roll” scheduled in London. In order to navigate himself to the event location, Alex may use the GPS coordinates associated with the Event ID 276 in integration with map based applications such as Google maps, or Apple maps. The location database 108 is populated by a data collection module 120 and is updated by a location module 126. The location database 108 may additionally be populated by one or more of the second system 136, the third party network 138, the third party database 140, the IoT data source 142, the user device 144, the camera 146, the sensor 148 or the DAW 150. The location database 108 is utilized by the event module 124 and the perspective module 128.

In some examples, each song in a compilation of music recordings from several tour dates can be tagged with a specific performance location such as major cities. This compilation may not only a collection of live performances but also an auditory journey through different geographical locations. For instance, the song ‘City Nights’ may have been recorded live in New York, while ‘Desert Echoes’ could be associated with a performance in Phoenix, Arizona. These songs, connected to their performance locations, can be visually represented on a map, overlaying the auditory journey with its geographical counterpart. Moreover, additional media associated with each location can further enrich the SIO. In some examples, images, text, video clips, concert posters, and social media posts from each concert can be integrated into the location-based visualization, providing a more immersive user experience. This can transform the act of listening to the compilation album into a multisensory journey through time and space, guided by the music.

Location Database 108 can also be utilized for music curation based on location. For instance, a user may desire to compile a playlist of all performances recorded at the renowned Royal Albert Hall in London, UK, between the years 1968 and 1969. By retrieving recorded performances tagged with this location and date range from the Location Database 108, the system can automatically curate the requested playlist.

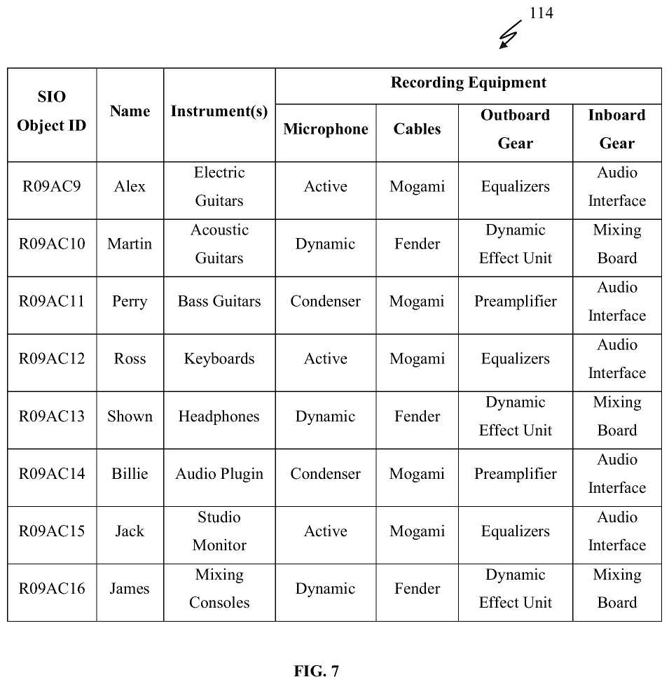

FIG. 5 is a table illustrating exemplary details about different exemplary types of subject data, in accordance with some examples. In a subject database 110, the exemplary types identified are Subject ID, Source ID, and Subject Description.

The subject database 110 stores data related to people participating in a music event or a song, or the characteristics describing those people. The subject data may comprise descriptions of specific people, or groups of people involved in a music event or people behind the creation of music. In some examples, subjects may include any data which is categorical in nature, or any attributes of categories. For example, a US instrumentalist Ross having Subject ID 654981 and Source ID 6541, may be associated with a music album called “Rock n Roll” in which he played an instrument. Likewise, Jack having Subject ID 132146 and Source ID 1464, may be associated with a music album called “Rock n Roll” in which he was an audio technician. The subject database 110 is populated by the data collection module 120 and is updated by the subject module 122. The subject database 110 may additionally be populated by one or more of the second system 136, the third party network 138, the third party database 140, the IoT data source 142, the user device 144, the camera 146, the sensor 148 or the DAW 150. The subject database 110 is utilized by the subject module 122 and the perspective module 128.

In some examples, an individual's musical preferences, personal characteristics, and associated subjective experiences can be categorized within the subject database 110. For instance, Ava, who is an avid listener and creator of music, could be linked with a Subject ID 221984 and Source ID 9846. Ava's musical tastes, which lean heavily towards blues and jazz, would be recorded in the database, contributing to a personal profile of her musical preferences. This could include favorite artists or bands, preferred instruments, and even the musical keys she finds most appealing. Furthermore, Ava's personal characteristics could be recorded, such as her tendency to listen to more melancholic music when she is in a reflective mood or more upbeat music when she is feeling energetic. This emotional relationship with music forms a critical part of her profile in the subject database 110. Additionally, Ava's subjective experiences related to music would also be stored. For instance, if Ava attended a jazz concert and had a profound emotional reaction to a particular performance, her description and experience of that event could be stored in the database. This can include her personal impressions of the musicians, her feelings during the performance, and how she perceived the concert environment. Similarly, if Ava created a blues song that was deeply personal and tied to a specific event in her life, her reflections on the creation process and the personal meaning behind the song would be part of her profile in the subject database 110. In this manner, the subject database 110 encapsulates the multifaceted relationship between a person and music. By storing and categorizing personal, emotional, and subjective data, the subject database 110 may create a comprehensive profile of a person's musical identity. This information, when utilized by other modules within the system, can lead to personalized music experiences, tailored music recommendations, and a deeper understanding of the complex relationships individuals have with music.

FIG. 6 is a table illustrating exemplary details about different exemplary types of creator data, in accordance with some examples. In a creator database 112, the exemplary types identified are SIO Object ID, Creator ID, Creator Name, and Creator Role(s).

The creator database 112 stores data associated with various contributors involved in the process of music creation. The creator data may comprise individuals, companies, and organizations who each play a vital role in the music production process. These contributors can range from performers and composers to engineers and production staff, or even record labels that have facilitated the release of the music. In one example, the creator database 112 prioritizes data pertaining to individuals who have made significant contributions to a piece of music. For instance, for a song album entitled “Fire” involving multiple contributors: Alex, Martin, and Matthew, Alex, who holds an SIO object ID of X39CE2 and a creator ID of MIC089, contributed as the lyricist, responsible for crafting the words of the songs in the album. The creator database 112 links Alex's unique IDs to all songs in the “Fire” album that he penned the lyrics for. Martin, bearing an SIO object ID of X39CE3 and creator ID MIC090, served as the composer, devising the melody and harmonies that define the musical backdrop of the album. Martin's SIO Object ID and creator ID are linked to all instances where his compositional work was utilized within the “Fire” album.

In a more comprehensive example, the creator database 112 may capture an intricate network of contributors involved in a song's production and release. For example, a song produced by a recording studio could involve a recording engineer named Stuart, who also served as the mix engineer and the mastering engineer. Stuart's IDs would then be linked to these various roles in the song's production. In the same example, technicians Ross and Smith contributed their technical skills to the production process. Their IDs would be attributed to the specific technical tasks they performed during the song's creation. Likewise, creative contributor Rowen, who can provide inputs on aesthetics or conceptual aspects of the song, and artist manager Jonas, who oversees the strategic and promotional aspects, would also have their IDs linked to the specific contributions they made. All these contributors are assigned unique SIO object IDs and creator IDs, which are cross-referenced in the creator database 112, establishing a detailed relational map of individuals and their specific contributions to any given musical piece. The creator database 112 is populated and updated by the data collection module 120 and the subject module 122. Furthermore, creator database 112 can receive additional data from multiple sources, such as the second system 136, the third party network 138, the third party database 140, the IoT data source 142, the user device 144, the camera 146, the sensor 148, or the DAW 150.

In some examples, the data stored in the creator database 112 may include the information relating to the allocation of fractional ownership over various individual audio tracks within a complete musical composition. This capability is critical when understanding the distribution of rights and royalties in the complex world of music production. For example, in a scenario where a rock band has full rights to a particular song and a DJ named Annie wishes to use a specific guitar track as a sample for her electronic album, the creator database 112, along with the SIO, may provide a pathway for DJ Annie to determine the ownership of the isolated guitar track. In this same case, the guitarist, known as Jake, of the rock band has performed the guitar track. According to the creator database 112, Jake holds the rights to this specific performance as it is linked to his unique SIO object ID and creator ID. The database maps his IDs to the specific guitar track in the song, establishing him as the fractional owner of that particular track, which allows DJ Annie to identify Jake as the rights owner of the guitar track she intends to sample. Consequently, DJ Annie may only need to acquire rights to this specific guitar track, as opposed to the entire song, to incorporate it in her electronic album. Upon the release of DJ Annie's album, the creator database 112 and SIO play another crucial role: connecting the sampled guitar track in DJ Annie's song to its original source, the guitar track in the rock band's song. The song on DJ Annie's album containing the sample bears an SIO object ID linking it to the original guitar track from the rock band's song. Hence, Jake's contribution as the original performer of the guitar track is recognized and linked to the new music work, further underscoring the precision and comprehensiveness of the creator database 112 and the SIO in preserving attribution in the complex musical landscape.

FIG. 7 is a table illustrating exemplary details about different exemplary types of equipment data, in accordance with some examples. In an equipment database 114, the exemplary types identified are SIO Object ID, Name of artist, Instruments, and Recording Equipment such as Microphones, Cables, Outboard Gears, and Inboard Gears.

The equipment database 114 stores data primarily related to names of the instruments used in creating a music piece. In some examples, the subject data stored in the subject database 110 may be linked to a specific SIO object ID in the equipment database 114 and the SIO object ID may be linked cither to an equipment or to an artist playing a specific instrument, or both. For example, the subject data may be linked to specific sets of instruments played in a musical concert, of an individual instrument played in a small music sample.

The equipment database 114 may also store recording equipment such as type of microphones, cables, outboard gear, inboard gear and storage type used in a music recording. For example, a music sample of time stamp 30 seconds can have an electric guitar played by Ales, which was recorded by using an active type microphone connected to the electric guitar with Mogami type cables. In the identical recording set up, an equalizer can be used as an outboard gear along with audio interface as an inboard gear, along with a digital type storage used to store the recorded music piece from the electric guitar. The above set up may be given a unique SIO object ID of R09AC0.

The equipment database 114 may also store different specifications for each of the instrument for example, model, manufacturer and configuration of the electric guitar used in the music sample, with each given a unique SIO object ID. Alternatively, different instruments may also be stored in the equipment database 114 with their corresponding specifications. For example, in a scenario where Ross is a music composer and wants to create a piece of music by using DAW 150, Ross wants to merge the sounds of a few instruments which he wishes to use in a final product. In such a case, Ross may integrate acoustic guitars by using SIO object ID as R09AC10, keyboards by using SIO object ID as R09AC12 and a bass guitar by using SIO object ID as R09AC11. The equipment database 114 is populated by the data collection module 120 and is updated by the subject module 122. The equipment database 114 may additionally be populated by one or more of the second system 136, the third party network 138, the third party database 140, the IoT data source 142, the user device 144, the camera 146, the sensor 148, or the DAW 150.

In one illustrative example, the equipment database 114 may be used in the context of a full orchestral recording. The equipment database 114 may comprise a diverse range of data primarily pertaining to musical instruments and associated equipment utilized in the creation of music pieces. These data points are linked to specific SIO object IDs which may associate with an equipment, an artist playing a specific instrument, or a combination thereof. For example, a professionally recorded orchestral performance may involve a variety of musical instruments across the strings, brass, woodwind, and percussion families. A specific violin, as part of the string family, can be identified by its make, model, and serial number, all documented in the equipment database 114 with an associated SIO object ID of V09AC1. Additionally, equipment associated with the instruments, such as the type of strings used on the violin, marked with another unique SIO object ID, S09AC2 for instance, may be documented. Similarly, the type of baton used by the conductor, the acoustic treatments in the recording room, the microphones and their configurations, the stands holding up the microphones, and the specific cables used to connect the microphones to a patch bay can all be traced within the equipment database 114, each having their unique SIO object IDs. Moving further along the signal path, the patch bay itself, the outboard audio processing gear like the compressor, equalizer, reverb, and more, the audio console, the digital audio interface, and the Digital Audio Workstation (DAW) used, as well as any plugins used in the DAW, are all identifiable with their unique SIO object IDs in the equipment database 114.

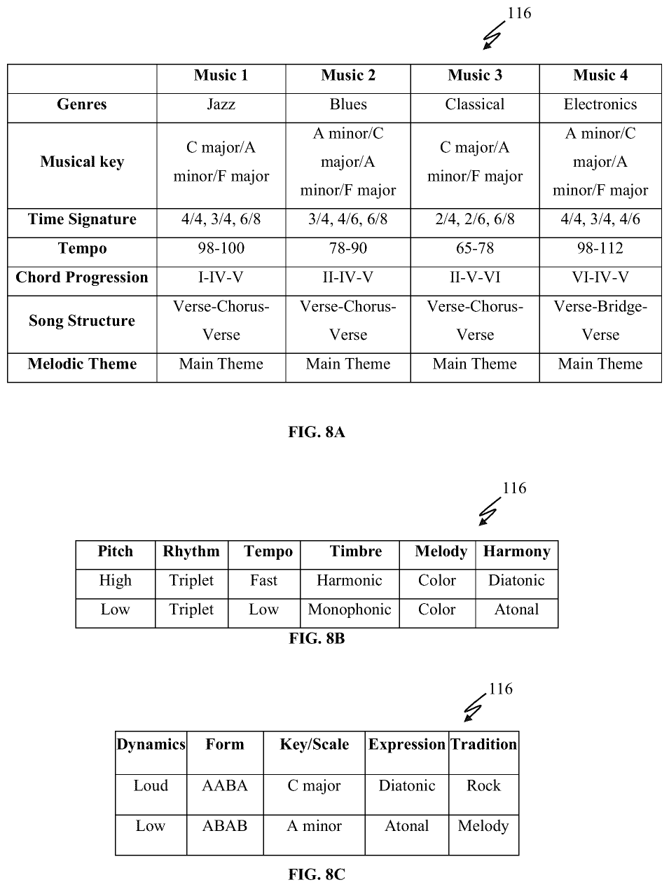

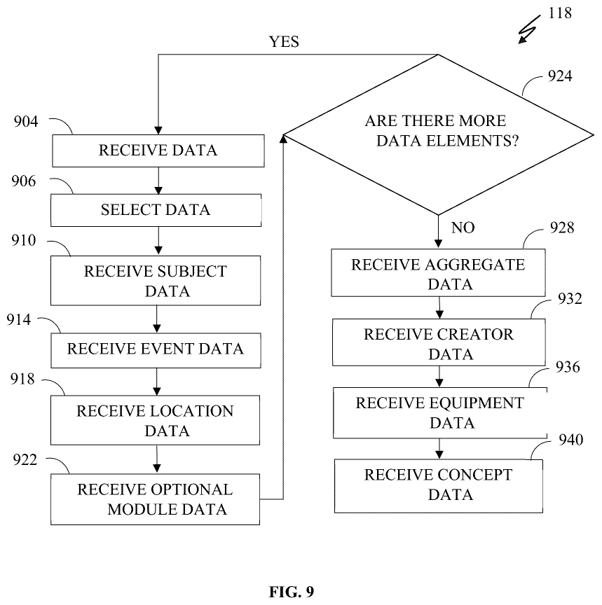

FIGS. 8A-8C illustrate tables with exemplary details about different exemplary types of concept data, in accordance with some examples. In concept databases 116, the exemplary types identified are Genres, Musical Key, Time Signature, Tempo, Chord Progression, Song Structure, and Melodic Theme for a set of music.

In some examples, the concept database 116 stores data related to patterns used for creating the music. The patterns may include pitch (e.g., high, low, or a combination thereof), rhythm (e.g., triplet, or a combination thereof), tempo (e.g., fast, slow, or a combination thereof), timbre (e.g., harmonic, monophonic, or a combination thereof), melody, harmony (e.g., diatonic, atonal, or a combination thereof), dynamics, form, key/scale, expression, tradition, genres (jazz, rock, or a combination thereof). For example, in a case where a music company launches Music 1 and Music 2, Music 1 may belong to jazz genre, musical music keys C major/A minor/F major, with time signatures 4/4, 3/4, 6/8 at tempo 98-100 with chord progression of I-IV-V, with song structure Verse-Chorus-Verse and melodic theme of the music as main theme. Additionally, Music 2 may belong to Blues genre, musical keys A minor/C major/A minor/F major, with time signatures 3/4, 4/6, 6/8 at tempo 78-90 with chord progression of II-IV-V, with song structure Verse-Chorus-Verse and melodic theme of the music as main theme. Alternatively, different concepts may also be stored in concept database 116 and identified by their corresponding types. For example, when the music company additionally launches Music 3 and Music 4, a music mixer Perry may identify Music 1 and Music 3 as Jazz and Classical music to create a musical piece by mixing a Jazz composition with a classical arrangement. Further, Perry, by using DAW 150, may synchronize the tempo, song structure and chord progression of Music 1 and Music 3 to create a new music idea.

In some examples, the concept database 116 stores numerous musical concepts present in a song. For example, a multi-faceted song such as “Bohemian Rhapsody” by Queen can be analyzed to store general concepts pervasive throughout the song, such as the overarching styles of “Rock Opera” or “Pocket Symphony,” both of which can be given unique SIO object IDs (e.g., ROP01 and PSY01 respectively). Additionally, the concept database 116 also catalog specific musical concepts associated with different sections of the song. For example, the first section of “Bohemian Rhapsody,” which unfolds in the key of E flat major at a specific tempo, may be characterized by the songwriting style of a “ballad” (SIO object ID BAL02), and the use of specific instrument techniques such as arpeggios (SIO object ID ARP03). As the song progresses, another section can be associated with the concept of a “guitar solo” (SIO object ID GSO04), which could further be linked to a “major pentatonic” concept (SIO object ID MPE05). Every musical phrase could be associated with rhythmic notation concepts, such as quarter notes (SIO object ID QNO06), eighth notes (SIO object ID ENO07), triplets (SIO object ID TRI08), sixteenth notes (SIO object ID SNO09), and so forth. Moreover, the song's iconic part, also known as the “operatic section,” can be associated with concepts such as “choral arrangement” (SIO object ID CHA10), “counterpoint” (SIO object ID COU11), and “vocal harmony” (SIO object ID VHA12). Additional concepts for other sections of the song may include “reprise” (SIO object ID REP13), “overture” (SIO object ID OVE14), or a combination thereof. In this way, the concept database 116 provides a rich and complex understanding of the numerous musical concepts embodied within a single song, effectively mapping the intricate layers of musical composition and expression. The concept database 116 is populated by a data collection module 120 and is updated by a subject module 122. The equipment database 114 may additionally be populated by one or more of the second system 136, the third party network 138, the third party database 140, the IoT data source 142, the user device 144, the camera 146, the sensor 148, or the DAW 150.

FIG. 9 is a flow diagram illustrating a process performed by the server system 118, in accordance with some examples. At operation 904, the server system receives the identified data elements from the data collection module 120. For example, a data element may be a subject, John Smith who was a singer who performed music at the concert of Sunburn. The data elements may be an event, such as a live concert of Sunburn held on Jun. 6, 2018. In another example, the data element may comprise location data such as coastline called Cassis beach, France, where the live concert was organized. The data elements may additionally include names of other singers who took part in the live concert. The data elements may additionally comprise the equipment used in the live concert.

At operation 906, the server system 118 selects the data elements. The data elements may be selected from the at least one data element received from the data collection module 120. In one example, the server system 118 can select the singer, John Smith. Alternatively, the server system 118 can select the live concert of Sunburn at Cassis beach.

At operation 910, the server system 118 receives subject data from the subject module 122. The subject data can include people or things. Matching subjects are associated so as to add new details to an existing subject and/or corroborate existing details. Subject data may additionally be accompanied by a source score which indicates the reliability of the source. The reliability of the source may be retrieved from the source database 104 and/or may utilize a story corroboration system or other method of determining the reliability of the received data.

At operation 914, the server system 118 receives the event data from the event module 124. In some examples, the event data may comprise matched events and/or newly identified events. Events may comprise musical events, concerts, records, or other time-based data. In some examples, an event refers to something which occurred or the state of people, things, or a combination thereof, at a specific date and/or time. The resolution of time may be one or more years, months, weeks, days, hours, minutes, seconds, or a combination thereof. Matching events are associated so as to add new details to an existing event and/or corroborate existing details. Event data may additionally be accompanied by a source score which indicates the reliability of the source. The reliability of the source may be retrieved from the source database 104 and/or may utilize a story corroboration system for determining the reliability of the received data.

At operation 918, the server system 118 receives the location data form the location module 126. In some examples, the location data may comprise matched locations and/or newly identified locations. Locations may describe countries, regions, cities, towns, villages, streets, buildings, or a combination thereof, or may alternatively comprise a set of coordinates such as GPS or map coordinates. The resolution of location may comprise a distance or area of any scale ranging from inches or feet, millimeters or meters, to hundreds or thousands of miles or kilometers. In some examples, locations may be described by natural geographic features such as lakes, rivers, streams, mountains, valleys, canyons, or a combination thereof. Matching locations are associated so as to add new details to an existing location and/or corroborate existing details. Location data may additionally be accompanied by a source score which indicates the reliability of the source. The reliability of the source may be retrieved from the source database 104 and/or may utilize a story corroboration system or other method of determining the reliability of the received data.

At operation 922, the server system 118 receives data from one or more optional modules optional module(s): creator module 130, equipment module 132, and/or concept module 134. The optional modules query relevant database(s) and compare the selected data element to data stored in the relevant database(s) to identify matching data elements. The optional modules may compare specific data types beyond subject, event, or location data. For example, the creator module 130 may compare data relating to the singers participating a musical event. This may include the region or country of the singers, the number of people involved, or a combination thereof. Likewise, the data may comprise types of singers (e.g., rock genre singers, melody genre singers, or a combination thereof). Further, the equipment module 132 which may compare data relating to equipment used in the musical event. Examples may be guitar, drums, piano, violin or a combination thereof. Alternatively, the equipment module 132 may compare specifications of three different guitars used in a musical event. The equipment module 132 may determine which tool was used to create a digital object or asset, the equipment module 132 allows the verification and registering of the tool or device used to create the object into a system for defining and differentiating any digital asset. The concept module 134 may compare data specific to concepts used in a creation of music such as musical key, time signature, tempo, song structure, melodic theme, or a combination thereof. The optional modules store the results of data comparisons to relevant databases, which may additionally include a source reliability score. The received data may further include a source reliability score.

At operation 924, the server system 118 determines whether there are more data elements. In one example, the server system 118 may determine that there are more data elements. For example, when there is another data element comprising the description of a song, the server system 118 may be redirected back to operation 904 to receive additional data elements from the collection module 120 and thereby select the data element comprising the description of a media content. Alternatively, the server system 118 may determine that there are no more data elements. In this case, the server system 118 receives the aggregate data from the perspective module 128, at operation 928. In some examples, the aggregate data being assembled to form a story such as via a chronological account of events. The aggregate data may comprise a plurality of accounts, which may be summarized from a plurality of subject, event, or geography data. In some examples, the aggregate data may comprise generalizations or inferences from the available data. In other examples, the aggregate data may be more specific, for example, as a narrative describing a musical concert of a performer who played at the Sunburn event held on Jun. 6, 2018, where the story may provide details of the playlist with the time stamps.

At operation 932, the server system 118 receives additional creator data from the creator module 130, according to the process described in the above, at operation 922. At operation 936, the server system 118 receives additional equipment data from the equipment module 132, according to the process described in the above, at operation 922. At operation 940, the server system 118 receives additional concept data from the concept module 134, according to the process described in the above, at operation 922. The optional modules store the results of data comparisons to relevant databases, which may additionally include a source reliability score. The received data may further include a source reliability score.

An example illustrating the operation of the server system 118 gathering and analyzing data could be the following, in the case of a musical piece, “Symphony of Stars.”

The data collection module 120 gathers a comprehensive set of data that include digital media forms such as press releases about the song's release, social media posts by The Astrals, and/or recording studio data. This establishes a robust data foundation for the musical piece. This raw data, along with its origins, is stored in the source database 104. This database serves as both a store of raw data and a reference point for assessing the data's accuracy and validity.

Following this, the subject module 122 parses subjective experiences related to the creation of “Symphony of Stars.” It dissects text-based data sources, identifying personal experiences of The Astrals that potentially influenced the song's composition. This can include life events, such as a band member witnessing a meteor shower, which inspired the song's theme. The discerned subjective experiences and insights are compiled into subject database 110, providing a subjective lens to understand the song.

The event module 124 delineates temporally-significant data associated with “Symphony of Stars.” The event module 124 categorizes key events such as when The Astrals first wrote the song, the recording sessions, and the song's live debut. This data is organized and stored within the event database 106, creating a chronological roadmap of the song's progression from conception to completion.

The location module 126 isolates geographical data tied to the creation of “Symphony of Stars.” It tracks locations such as where the song was written, perhaps under the starlit sky at a band member's countryside home, and where it was recorded, like the renowned Abbey Road Studios in London. This data is channeled into the location database 108, providing a spatial context to the song creation process.

The creator module 130 identifies and catalogues everyone involved in the creation of “Symphony of Stars.” This includes not only The Astrals band members but also supporting staff such as the sound engineer, the producer, and even a local astronomer who may have inspired the song's theme. This information is populated into the creator database 112, acknowledging every contribution to the song's creation.

The equipment module 132 details each piece of equipment involved in the production and performance of “Symphony of Stars,” such as a Fender Stratocaster guitar or a Neumann U87 microphone. This data is fed into the equipment database 114, forming a robust catalogue of the physical resources used to create the song.

Lastly, the concept module 134 dissects “Symphony of Stars” to identify and categorize inherent musical concepts. For instance, it may identify the song's key, tempo, the chord progression, and the usage of cosmic sound effects to mimic the theme. This analytical data is stored in the concept database 116, offering a deep understanding of the song's unique musical elements.

The synergistic operation of these modules results in an intricate, multi-dimensional data matrix, allowing for a comprehensive understanding and examination of “Symphony of Stars.”

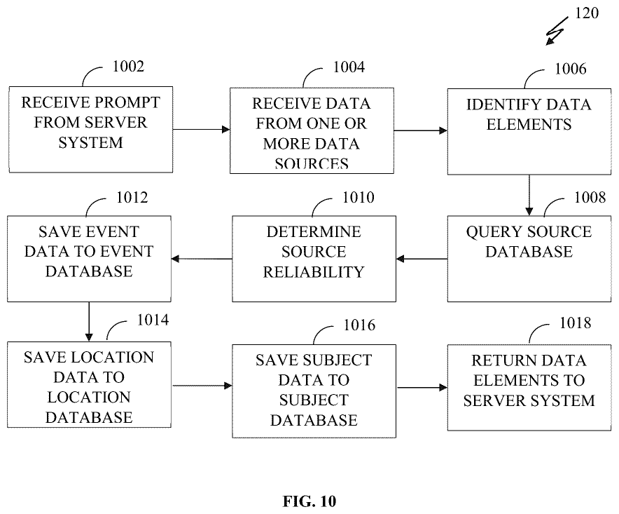

FIG. 10 is a flow diagram illustrating a process performed by a data collection module 120, in accordance with some examples. This process begins at operation 1002, where the data collection module 120 receives a prompt from the server system 118 to begin collecting data form at least one user and/or data source. At operation 1004, the data collection module 120 receives data from at least one or more user or data sources. In some examples, the data source may comprise a user using a user device 144. The user may manually input data via a physical or virtual keyboard interface or may alternatively dictate the input data verbally or upload one or more images taken by one or more cameras 146. The data source may alternatively comprise any of a second system 136, third party network 138, third party database 140, IoT Data Source 142, camera 146, sensors 148, a user device 144, or the DAW 150. The data collection may be passive, such as passively recording from a camera 146 or one or more sensors 148 which may include a microphone. Likewise, a camera 146 may be one or more security cameras observing one or more individuals, locations, events, or a combination thereof.

In one example, the recordings of a musical event using a microphone by a user named Alex, can be received by the data collection module 120. Similarly, the recordings of a music made by another user named Martin, which was recorded in a recording studio, can be received by the data collection module 120 through a website Martin has saved. In other examples, users can manually input data to the data collection module 120 through a physical or virtual keyboard interface, or they may dictate the input data verbally or upload images taken by the camera 146.

At operation 1006, the data collection module 120 identifies at least one data element from the received media content. In some examples, the data element can include people involved in the media content, music details, location of a music event, time of a music event, or a combination thereof. The data elements are identified differently depending on the format of the data, which could be provided as text, a transcription, or an audio dialogue. Alternatively, the data could be subjected to an algorithm or utilize machine learning, optical character recognition (OCR), and/or artificial intelligence to use methods such as a convolutional neural network to segregate the content into discrete elements while additionally accounting for context. The data collection module may further identify metadata related to the creation of the object (e.g., a song) and allow the creator (e.g., owner) to add any unique metadata fields (description, materials, inspiration, name, title, or a combination thereof) that further define and differentiate the object.

At operation 1008, the data collection module 120 queries the source database 104 to determine a score indicating the reliability of the data source from which the media content data was received. The data score may be binary, indicating whether the data source is trustworthy or not. Alternatively, the data score may be a fixed scale with varying degrees of trust or reliability between a minimum and maximum values. In some examples, the source reliability score is numerical and not on a fixed scale, and a larger number implies a more reliable source.

At operation 1010, the data collection module 120 determines the reliability of the source, by retrieving a source score from the source database 104. In some examples, the source score for the current data source can be 432 or 555. In some examples, if the source does not have a source score, a default value of 100 is assigned. In other examples, a story verification system verifies and corroborates the accuracy of the contributed story to determine the source reliability score.

At operation 1012, the data collection module 120 saves the identified event data into the event database 106. In some instances, this event data can represent the venue of a live concert, like the city of Paris, France. The event data can also encompass references to specific landmarks or locations within the city, such as Petit Bain, Bataclan, National Estate of Saint-Cloud, or a combination thereof. The event data may additionally comprise a source reliability score.

At operation 1014, the data collection module 120 saves the identified location data into the location database 108. In some instances, this location data can represent the venue of a live concert, like the city of Paris, France. The location data can also encompass references to specific landmarks or locations within the city, such as Petit Bain, Bataclan, National Estate of Saint-Cloud, or a combination thereof. For example, if Alex records his music in Paris, France, this location becomes part of the location data. In another example, if Martin has his music studio situated in Madrid, Spain, the location becomes a part of the location data. The location data may additionally comprise a source reliability score.

At operation 1016, the data collection module 120 saves the identified subject data into the subject database 110. Subject data can refer to a range of information. For example, the subject data may include the data relating to Alex, who is a singer, or even the name of the microphone he used, and the location where the recording was made. In another example, the subject data could be about Martin, who is a music composer, and could include details such as the name and location of his music studio. Subject data can also include information about a singer who participated in a live concert. The subject data may additionally comprise a source reliability score.

At operation 1018, the data collection module 120 returns the identified data elements and source reliability scores to the server system 118. The data collection module 120 can be generated, organized, categorized, interpreted, or otherwise modified by an artificial intelligence or machine learning algorithm. It could be a large language model (LLM) that's trained on extensive datasets to produce human-like story data based on prompts from a user, a system, or a combination thereof.

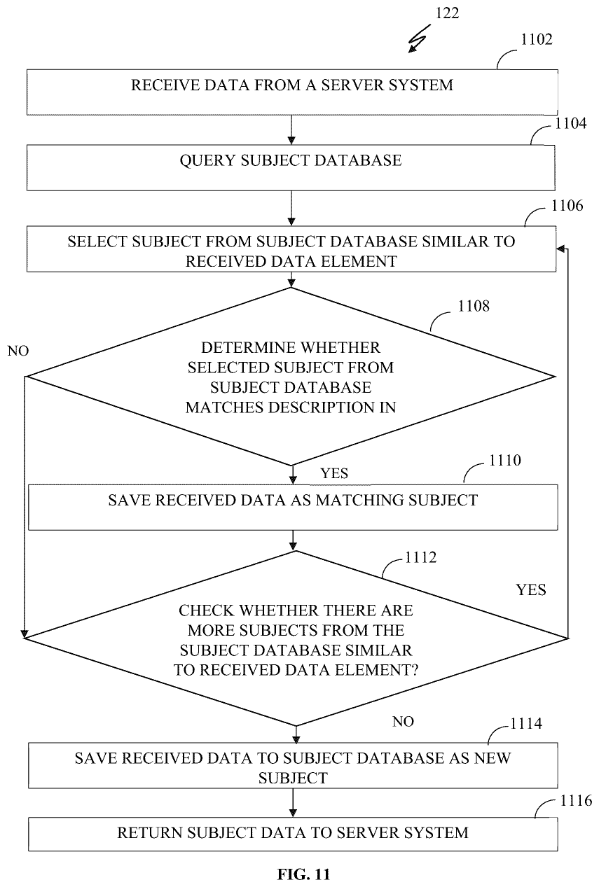

FIG. 11 is a flow diagram illustrating a process performed by the subject module 122, in accordance with some examples. At operation 1102, the subject module 122 receives the media content from the server system 118. In some examples, the media content comprises identified data elements, which may include data elements representing subjects such as people participating in a music event, and/or in a song. The subject may be specific, such as a specific person, or may be more general, such as referring to all or any person matching a description, such as all the songs played by John Smith. In an example where a music concert of Sunburn was held in city of London, the data elements are location of the concert, type of concert, people in the concert, or a combination thereof. In another example where there was a music recording held in a music studio, the data elements are the location of the studio, name of the studio, playback singer of the studio, instrument used, or a combination thereof.

At operation 1104, the subject module 122 queries the subject database 110, for subject data which is similar to the received subject data element extracted from the media content. In one example, if one of the received subject data elements comprises a description of a singer, then the subject module 122 queries the subject database 110 for data related to singers. In another example, if one of the received subject data elements comprises description of instrument, then the subject module 122 queries the subject database 110 for data related to instruments. In another example, if the received subject data elements relate to a musical event, then the subject module 122 queries the subject database 110 for data related to music events.

At operation 1106, the subject module 122 selects a subject from the subject database 110 similar to the received data element. In one example, where the received data element is a description of a singer, the subject module 122 selects a subject from the subject database 110 describing a singer. In another example, where the received data element is a description of an instrument, the subject module 122 selects a subject from the subject database 110 describing an instrument.

At operation 1108, the subject module 122 determines whether the selected subject from the subject database 110 matches the description in the received data element. In some examples, matching a specific singer may require that the genre of the singer is the same, as well as a name, and/or a description of the singer including height, build, facial features, country, or a combination thereof. It may be noted that the data do not need to be an exact match but should not comprise any unresolved conflicts. For example, if the height is off by an inch, but all other descriptions match, there may be a discrepancy with the height approximation, but it may still be concluded that both descriptions reference the same individual. In this case, the subject module 122 may proceed to save the received data as matching subject, at operation 1110.

In another case, the subject module 122 determines that the selected subject data do not match the received data element. In some examples, if the descriptions have a key detail which cannot be resolved, such as the name on a name tag, then the discrepancy cannot be resolved, unless the description included a statement that the individual was wearing another person's nametag. It may be noted that a data match may either be exact or may be generalized or more relative. For example, the received data describes an American singer standing 5′ 10″ with the last name Smith, whereas the selected subject data describes a singer standing 6′ 1″ having a name tag with the last name Jones, therefore the selected subject does not match the received data. In this case, the subject module 122 may proceed to operation 1112, to check whether there are more subjects from the subject database 110 which are similar to the received data element. In one case, the subject module 122 may check that there are more similar subjects. If so, the subject module 122 may be redirected back to operation 1106, to select additional similar subjects again. In some examples, an additional element describes another singer in the same live concert.

In another case, the subject module 112 checks that there are no additional subjects similar to the received data element and proceed to save the received data to the subject database 110 as a new subject, at operation 1114. A source reliability score may additionally be determined and saved to the subject database 110 with the new subject data. In some examples, the source reliability score may be a default value.

At operation 1116, the subject module 122 returns the subject data to the server system 118. The subject data may comprise the received data elements and/or the data elements from the subject database 110 to which it matched.

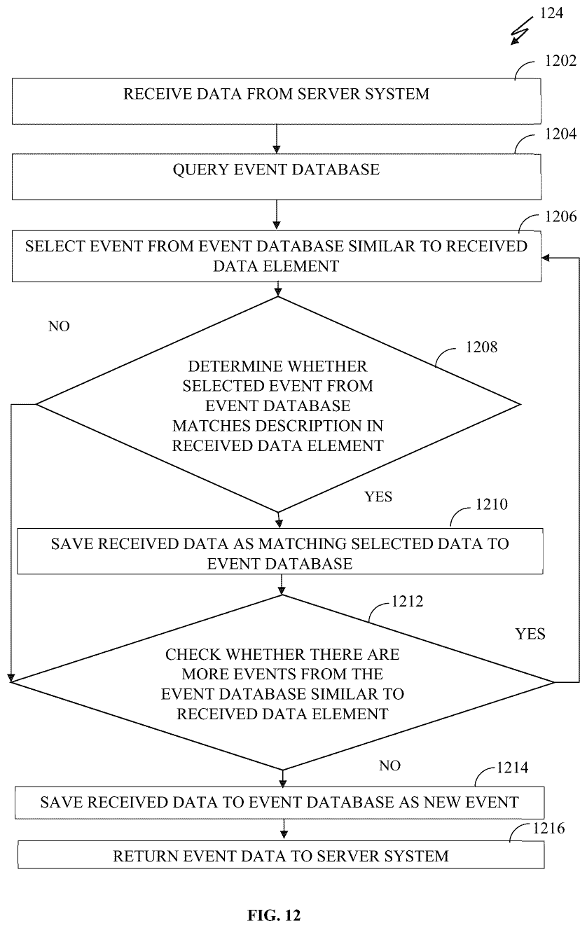

FIG. 12 is a flow diagram illustrating a process performed by an event module, in accordance with some examples. At operation 1202, the event module 124 receives media content from the server system 118. In some examples, the data extracted from the media content may include time-related events related to music or data comprising time-based data such as one or more dates, times, year of publishing music and may additionally include descriptions and/or characteristics of the music that was released at a specific date and/or time. The event data may be comprised any of a range of resolutions, such as a year, month, week, day, hour, minute, second, or a combination thereof, and may further comprise a time period which may be segmented accordingly, such as the Middle Ages, modern era, before modern era. For example, for an acapella concert was held in Mumbai, the time-based data can be the time period between June-August 2018, during which the acapella concert was held. In another example, for a concert was held in Delhi, the time-based data can be Jun. 19, 2018, the date which the band named Lexus held the concert.

At operation 1204, the event module 124 queries the event database 106, for event data which is similar to the received event data element. For example, if one of the received event data elements comprises a description of music acapella concert the event module 124 queries the event database 106 for data related to acapella concerts. In another example, if one of the received event data elements comprises a description of a live concert by Lexus, then the event module 124 queries the event database 106 for data related to live concerts. If the received event data elements relate to a music produced in a music studio, then the event module 124 queries the event database 106 for data related to music studio. Further, data may also relate to token codes for NFT and NFT values for sale.

At operation 1206, the event module 124 selects an event from the event database 106 similar to the received data element. In one example, where the received data element comprising the description of the live concert, the event module 124 selects an event from the event database 106 describing the live concert. For example, the event module 124 may select an event from the event database 106 similar to music shows held between 2017-2020. In another example, the event module 124 may select an event from the event database 106 similar concerts in held in the location of Delhi between 2016-2019.

At operation 1208, the event module 124 determines whether the selected event from the event database 106 matches the description in the received data element. In one example, the selected event may be sufficient to confirm that both descriptions describe the same event. For example, the descriptions could be confirmed by matching the name of the music show, time period of the music show, or a combination thereof. In another example, the matching description of live concert of Lexus may comprise identifying the types of songs played, number of people present in the concert, singers involved, location, and/or types of equipment used. In another example, when the received data describes number of tickets booked in the event was 10,000, and the data is determined to be a match as live concert of Lexus sold more than 10,000 tickets. In this case, the event module 124 may proceed to save the received data as matching the selected data to the event database 106, at operation 1210.

The event module 124 may determine that the selected event from the event database 106 do not match the description in the received data element. For example, the received data describes number of tickets booked in the event was 9,000. The data is not a match as live concert of Lexus sold more than 10,000 tickets. In such a case, the event module 124 may proceed to check whether there are more events from the event database 106 which are similar to the received data element, at operation 1212. In one example, if the event module 124 determines that there are more similar events, then the event module 124 returns to operation 1206 to select an additional event. In some examples, an additional element can describe a live concert of Sunburn. At operation 1214, the event module 124 proceeds to save the received data to the event database 106 as new event if it determines that there are no additional events similar to the received data element. A source reliability score may additionally be determined and saved to the event database 106 with the new event data. In some examples, the source reliability score may be a default value. At operation 1216, the event module 124 returns the event data to the server system 118. In some examples, the event data may comprise the received data elements and/or the data elements from the event database 106 to which it matched.

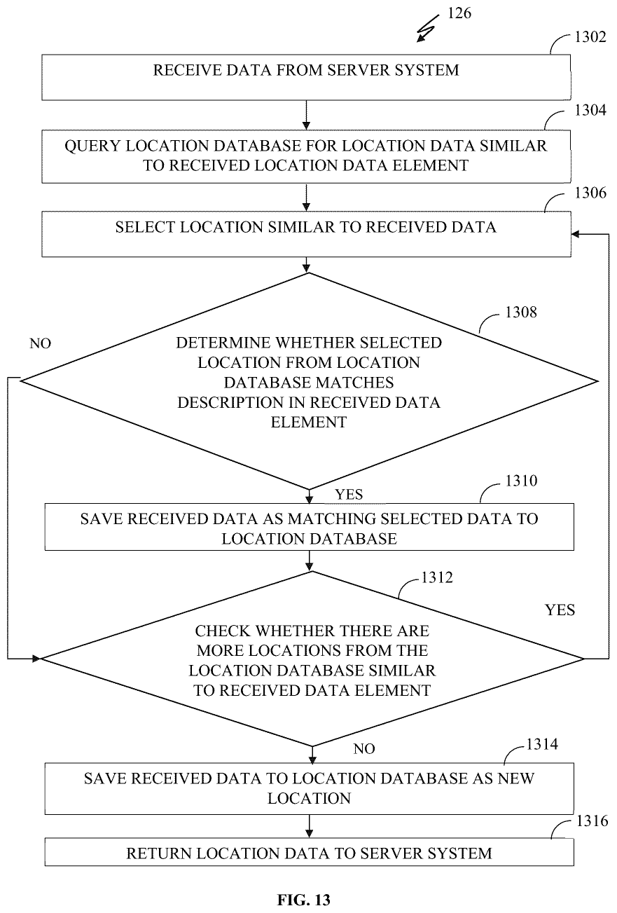

FIG. 13 is a flow diagram illustrating a process performed by a location module, in accordance with some examples. At operation 1302, the location module 126 receives data from the server system 118. In some examples, the data may include identified data elements representing locations such as countries, states, provinces, cities, towns, streets, buildings, GPS coordinates, or a combination thereof. In some examples, the location may alternatively refer to natural features such as a mountain, river, ocean, lake, or a combination thereof.

At operation 1304, the location module 126 queries the location database 108 for location data which is similar to the received location data element. For example, if one of the received location data elements comprise a description of a live concert on the coast of France, then the location module queries the location database 108 for data related to coastal regions in France. In some examples, the location database 108 may further specify coastal regions where the live concert occurred, further refining the data query.

At operation 1306, the location module 126 selects a location from location database 108 similar to the received data element. For example, the received data element may include the description of the live concert on the coast of France, therefore the location module 126 selects a location from the location database 108 describing coastal regions in France. In some examples, the coastal regions may be identifiable based upon names given to beaches, town or city names, or names assigned to operational regions used during one or more concerts during one or more events. For example, the location module can select the beaches of Paris, France. In another example, the received data element may include the description of the live concert in the city of England, therefore the location module 126 can select a location from the location database 108 describing cities of London, England.

At operation 1308, the location module 126 determines whether the selected location from the location database 108 matches the description in the received data element extracted from the media content. In some examples, the selected location may be sufficient to confirm that both descriptions describe the same location. For example, the descriptions could be confirmed by matching a live concert on the coast of France may comprise matching location names, GPS coordinates, physical landmarks, or descriptions of the terrain. In another example, matching a live concert held in London comprise matching location names, GPS coordinates, physical landmarks, or descriptions of the terrain. When the received data element matches the selected location from the location database 108, the location module, at operation 1310, saves the received data as matching the selected data to the location database. For example, if the received data describes a live concert on the coast of France, and the location module determines that the beach/coast depicted in an image matches a region of the beaches of Paris, France, specifically Cassis beach it saves the received data as matching the selected data to the location database 108, saving the location of Paris for the concert of Sunburn. A source reliability score may additionally be determined and saved to the location database 108 with the matched data.

The location module 126 may determine that the selected location from the location database 108 do not match the description in the received data element. For example, where the received data describes a live concert on the coast of France, the location module 126 can determine that the beach/coast, depicted in an image, does not match with a region of the beaches of Paris, France, specifically Cassis beach. In such a case, the location module 126, at operation 1312, proceeds to check whether there are more locations from the location database 108 which are similar to the received data element. In some examples, the location module 126 may determine that there are more similar locations. In such a case, the location module 126 may be redirected to operation 1306 for selecting an additional location. Alternatively, the location module 126 may determine that there are no additional locations similar to the received data element. In this case, the location module 126, at operation 1314, saves the received data to the location database 108 as a new location. A source reliability score may additionally be determined and saved to the location database 108 with the new location data. In some examples, the source reliability score may be set to a default value. For example, the source reliability score for a concert of Sunburn is given as 176 of 200. In another example, the source reliability score for a concert of Rock n Roll is given as 150 of 200. At operation 1316, the location module 126 returns the location data to server system 118.

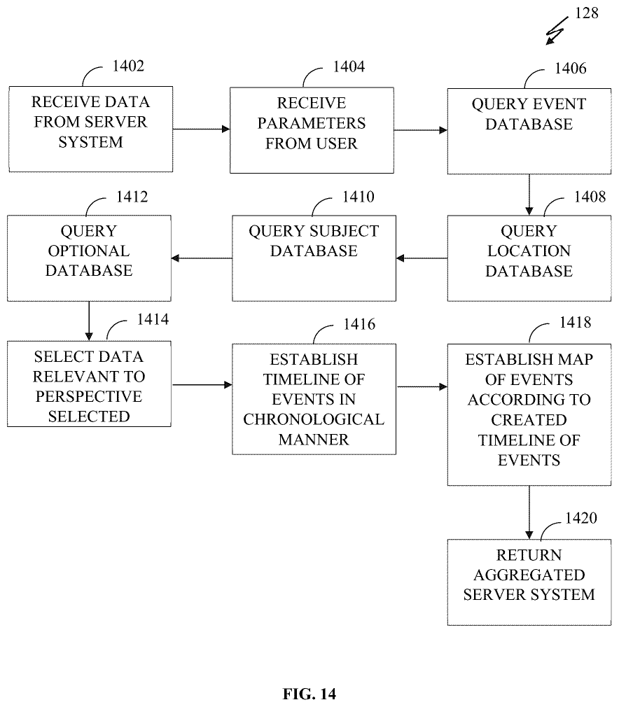

FIG. 14 is a flow diagram illustrating a process performed by a perspective module, in accordance with some examples. At operation 1402, the perspective module 128 receives data from the server system 118. This data could include various identified data elements such as information related to recorded music, names of songs, or details about live concerts, among other things. At operation 1404, the perspective module 128 gathers parameters from a user. These parameters represent the specific type of data the user seeks to extract. For instance, Alex may find songs in the “Jazz” genre from a Sunburn concert, inputting “Jazz” as a parameter. Alternatively, Martin may identify singers who perform “Rock” genre songs for the Sunburn concert, inputting “Rock” as a parameter.

At operation 1406, the perspective module 128 queries the event database 106. Depending on the user's perspective, the perspective module 128 may look for event data that aligns with that perspective. If the user perspective includes a description of a live Sunburn concert, for example, the perspective module 128 can search the event database 106 for data related to live concerts. If the user perspective involves a certain type of singer, it could query the event database 106 for different singers' names.

At operation 1408, the perspective module 128 queries the location database 108. Here, it looks for locations that match the received location data element. If the event data includes a description of a live Sunburn concert on the coast of France, for example, it can query the location database 108 for data related to coastal regions in France. It can further refine the data query to specify the exact coastal regions where the concert took place. In another example, if Martin is looking for singers from the North American region, the location database 108 can further specify regions within North America to refine the query.

At operation 1410, the perspective module 128 queries the subject database 110. It searches for subject data that aligns with the received subject data element. It could look for data related to the Sunburn concert and Jazz music, for instance, if the subject data includes a concert name and music type. Alternatively, if the subject data includes a description of a singer, it can query the subject database 110 for data related to the singers who participated in specific live concerts.

At operation 1412, the perspective module 128 queries optional databases, which include the creator database 112, the equipment database 114, and the concept database 116. These databases can provide specific data types that go beyond subject, event, or location data. The perspective module 128 can query the creator database 112 for data on a Sunburn concert or singers based in North America, including their regions, the number of people involved, and the types of singers (e.g., rock genre, melody genre, or a combination thereof).

At operation 1414, the perspective module 128 selects data that aligns with the user's selected perspective. For instance, the user could have chosen parameters such as a list of songs played at a Sunburn live concert in the “Jazz” genre, or a list of Rock genre singers based in North America.

At operation 1416, the perspective module 128 establishes a timeline of events in chronological order. This timeline can show, for example, that Jazz songs at the concert started at 08:00 AM and changed every 5 minutes, or it can display a list of singers with their locations and the number of songs they sang.

At operation 1418, the perspective module 128 creates a map of events according to the established timeline. The perspective module 128 can tie together details of songs, names of singers at the Sunburn concert, and timelines, all associated with their SIO object ID. In another example, it can compile details about the singers and songs, along with timelines, and connect them with their SIO object ID.

At operation 1420, the perspective module 128 sends the aggregated data back to the Server System 118. This data could comprise details about the singers, songs, and timelines, all tied together with their respective SIO object IDs.

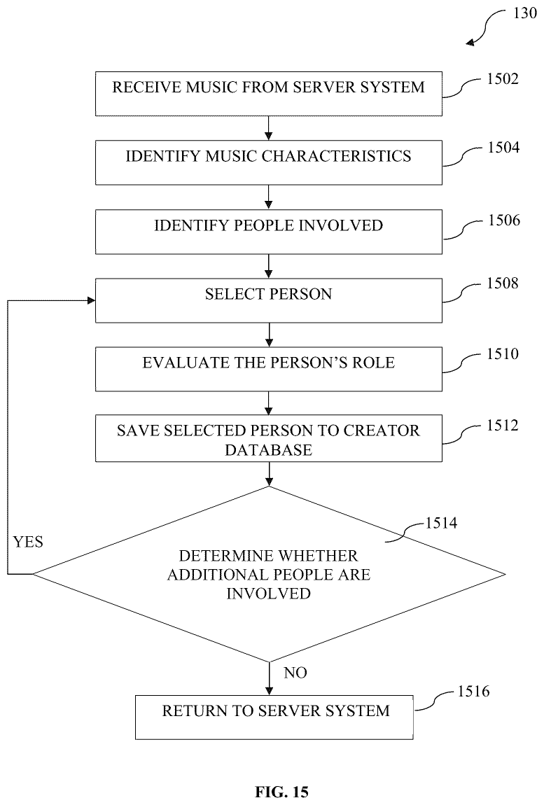

FIG. 15 is a flow diagram illustrating a process performed by a creator module 130, in accordance with some examples. The process begins with the creator module 130 receiving, at operation 1502, media content from the server system 118. At operation 1504, the media content identifies media characteristics which may include the people involved in the media content. At operation 1506, the creator module 130 identifies the people involved in the creation of media content and their numbers. For example, the people involved can be seven singers from the Washington music studio or the 30 singers from the “Superstars” show. At operation 1508, the creator module 130 selects one of the people identified. For example, the creator module 130 can select Perry, one of the identified individuals, from a music album. At operation 1510, the creator module 130 evaluates the selected individual's role in the media content. For example, Perry could be a singer in a music album, or Martin, who is another individual identified, could be a participant in a music show. At operation 1512, the creator module saves the selected person to the creator database 112. For example, Perry could be saved with the role of Singer, a SIO object ID of X39CE4, and a creator ID of MIC091. Martin, alternatively, could be saved with the role of Participant, a SIO object ID of X39DE7, and a creator ID of MIC062. At operation 1514, the creator module 130 determines whether additional people were involved in the media content. If another person was involved in the music album, the creator module 130 would return to operation 1508 to select this person. For example, this could involve selecting Alex, who is the lyricist of the album and is assigned a SIO object ID of X39CE2 and a creator ID of MIC089. Similarly, the process would go back to operation 1508 if there were other participants in the music show, such as Murphy, who has a SIO object ID of X89CE4 and a creator ID of MIC063. If the creator module 130 determines that no additional people were involved in the music, it returns to the server system 118 at operation 1516.

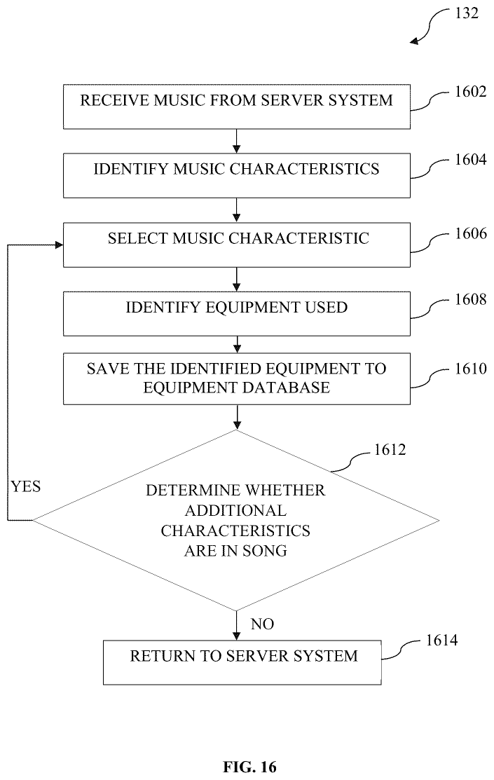

FIG. 16 is a flow diagram illustrating a process performed by an equipment module 132, in accordance with some examples. At operation 1602, the equipment module 132 receives media content from the server system 118. In some examples, the media content could be a music album or a music show. For example, the media content can be an album released by a music studio named “Fire”, or a music show called “Superstar”. At operation 1604, the equipment module 132 identifies media characteristics, which may include the characteristics of a music album, or additionally, a central segment of a song. For example, the album “Fire” may have a release date of Aug. 14, 2019, include seven singers, and have a recording location in Washington, United States, in a music studio. In an alternative or additional example, the “Superstars” show may have aired between June and August 2019. In some examples, the media characteristic can be the chorus of a song from the album. At operation 1606, the equipment module 132 selects a particular media characteristic. At operation 1608, the equipment module 132 identifies the equipment used in the selected characteristic. For instance, an electric guitar can be identified to have been used to play the chorus of the selected song from the album “Fire.” At operation 1610, the equipment module 132 saves the identified equipment to the equipment database 114. For example, the equipment module 132 can save the identified instrument, an electric guitar, along with its corresponding SIO object ID R09AC9. At operation 1612, the equipment module 132 determines if the media content possesses additional characteristics. If the equipment module 132 identifies more characteristics, it returns to operation 1606 to select and analyze the additional characteristic. For example, the additional characteristic can be a bridge of the song in addition to the chorus being identified and processed according to the above operations. If the equipment module 132 determines that there are no more additional characteristics in the media content, it returns to the server system 118 at operation 1614.

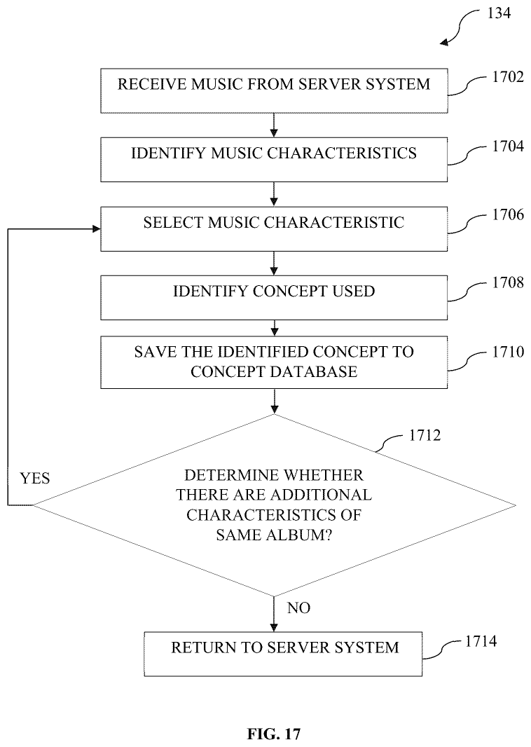

FIG. 17 is a flow diagram illustrating a process performed by a concept module 134, in accordance with some examples. At operation 1702, the concept module 134 receives a media content from the server system 118. The media content may include a music album, or an existing song being used for the creation of a new song. For example, the music album, “Fire,” released by a music studio, or an existing song, “Backlight”, that a composer named Alex is aiming to use for composing a new song. At operation 1704, the concept module 134 identifies the media content's characteristics. These media characteristics can include the release date of the content, the people involved in the creation of the media content, the segments of, and/or the genre of the media content. For example, the album “Fire” may have been released on Aug. 14, 2019, and involves seven singers who recorded in a music studio located in Washington, United States. In another example, the song “Backlight” can contain four bridges and is of the Jazz genre. At operation 1706, the concept module 134 selects one or more of media characteristics identified. At operation 1708, the concept module 134 identifies the concepts, or the data elements extracted from the chosen characteristic. For example, a chorus of a song from the album “Fire” can have concepts including musical keys C major/A minor/F major, time signatures 4/4, 3/4, 6/8, a tempo of 98-100, and a chord progression of I-IV-V. In another example, in the chorus of the song “Backlight”, the concepts could involve the musical keys A major/A minor/C major, time signatures 4/4, 3/4, 6/8, a tempo of 96-101, and a chord progression of I-IV-V. At operation 1710, the concept module 134 saves the identified concept to the concept database 116. For example, the concept related to the song from the “Fire” album can be saved with a corresponding SIO object ID R09AC9, while the concept related to “Backlight” can be saved with a corresponding SIO object ID T09BA8. At operation 1712, the concept module 134 then determines if there are additional media characteristics in the same media content. If the concept module 134 discovers more features, such as a bridge, melody, or harmony, apart from the chorus, it redirects back to operation 1706 to select and analyze the additionally identified media characteristic. If the concept module 134 determines that there are no additional characteristics, it returns to the server system 118 at operation 1714.

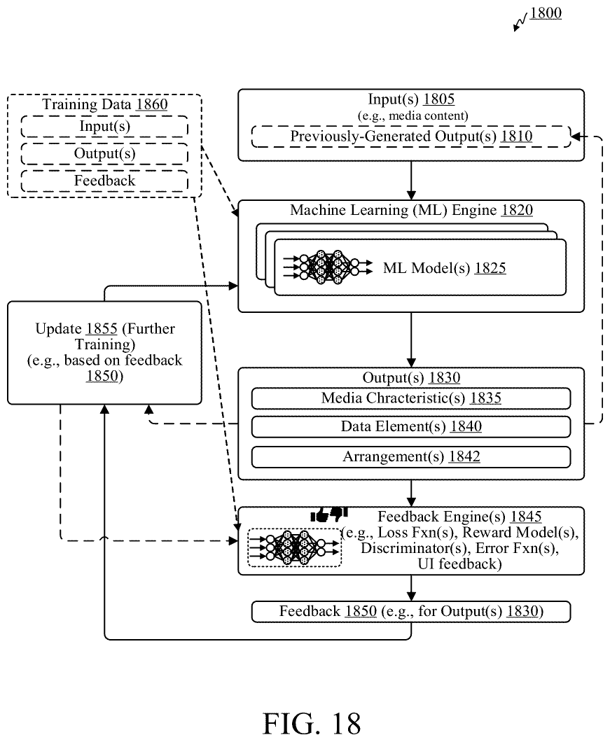

FIG. 18 is a block diagram illustrating an example of a machine learning system for training and use of one or more machine learning model(s) used to generate media characteristic(s), plurality of data element(s), and/or arrangement(s) of the plurality of data element(s), in accordance with some examples.

FIG. 18 is a block diagram illustrating an example of a machine learning system 1800 for training and use of one or more machine learning model(s) 1825 used to generate media characteristic(s) 1835, plurality of data element(s) 1840, and/or arrangement(s) 1842 of the plurality of data element(s) 1840. The machine learning (ML) system 1800 includes an ML engine 1820 that generates, trains, uses, and/or updates one or more ML model(s) 1825. In some examples, the media attribution system 100 include the ML system 1800, the ML engine 1820, the ML model(s) 1825, and/or the feedback engine(s) 1845, or vice versa.

The ML model(s) 1825 can include, for instance, one or more neural network(s) (NN(s)), one or more convolutional NN(s) (CNN(s)), one or more time delay NN(s) (TDNN(s)), one or more deep network(s) (DN(s)), one or more autoencoder(s) (AE(s)), one or more variational autoencoder(s) (VAE(s)), one or more deep belief net(s) (DBN(s)), one or more recurrent NN(s) (RNN(s)), one or more generative adversarial network(s) (GAN(s)), one or more conditional GAN(s) (cGAN(s)), one or more feed-forward network(s), one or more network(s) having fully connected layers, one or more support vector machine(s) (SVM(s)), one or more random forest(s) (RF), one or more computer vision (CV) system(s), one or more autoregressive (AR) model(s), one or more Sequence-to-Sequence (Seq2Seq) model(s), one or more large language model(s) (LLM(s)), one or more deep learning system(s), one or more classifier(s), one or more transformer(s), or a combination thereof. In examples where the ML model(s) 1825 include LLMs, the LLMs can include, for instance, a Generative Pre-Trained Transformer (GPT) (e.g., GPT-2, GPT-3, GPT-3.5, GPT-4, etc.), DaVinci or a variant thereof, an LLM using Massachusetts Institute of Technology (MIT)® langchain, Pathways Language Model (PaLM), Large Language Model Meta® AI (LLaMA), Language Model for Dialogue Applications (LaMDA), Bidirectional Encoder Representations from Transformers (BERT), Falcon (e.g., 40B, 7B, 1B), Orca, Phi-1, StableLM, variant(s) of any of the previously-listed LLMs, or a combination thereof.

In some examples, the layers and/or nodes represent interconnected filters, and information associated with the filters is shared among the different layers with each layer retaining information as the information is processed. The lines between nodes can represent node-to-node interconnections along which information is shared. The lines between nodes can also represent weights (e.g., numeric weights) between nodes, which can be tuned, updated, added, and/or removed as the ML model(s) 1825 are trained and/or updated. In some cases, certain nodes (e.g., nodes of a hidden layer) can transform the information of each input node by applying activation functions (e.g., filters) to this information, for instance applying convolutional functions, downscaling, upscaling, data transformation, and/or any other suitable functions.

In some examples, the ML model(s) 1825 can include a feed-forward network, in which case there are no feedback connections where outputs of the network are fed back into itself. In some cases, the ML model(s) 1825 can include a recurrent neural network, which can have loops that allow information to be carried across nodes while reading in input. In some cases, the network can include a convolutional neural network, which may not link every node in one layer to every other node in the next layer.

One or more input(s) 1805 can be provided to the ML model(s) 1825. The ML model(s) 1825 can be trained by the ML engine 1820 (e.g., based on training data 1860) to generate one or more output(s) 1830. In some examples, the input(s) 1805 may include information 1810. The information 1810 can include, for instance, media content, media characteristics, and/or data elements regarding a person, a source, location or time of a media event, sensor data, or attributes, characteristics, qualities, and traits associated with media content, or a combination thereof.

The output(s) 1830 that ML model(s) 1825 generate by processing the input(s) 1805 (e.g., the information 1810 and/or the previous output(s) 1815) can include media characteristic(s) 1835, plurality of data clement(s) 1840, and/or arrangement(s) 1842 of the plurality of data clement(s) 1840. The media characteristic(s) 1835 can include, for instance, audio characteristics (e.g., a musical key, a genre, a bridge, a chorus, a melody, a harmony, or a combination thereof), video characteristics, image characteristics, or a combination thereof. The plurality of data element(s) 1840 can include, for instance, data elements associated with a creation of the media content (e.g., a pitch, a rhythm, a tempo, a timbre, a melody, a melodic theme, a harmony, a dynamic, a form, a musical key, a musical scale, a time signature, a musical expression, a musical tradition, a genre, a musical narrative, a song structure, a location associated with the media content (e.g., where the media content was created or edited), metadata associated with the media content, an event associated with the media content (e.g., during which the media content was created, modified, distributed, or output), or an identifier of a person associated with the media content (e.g., a creator, modifier, distributor, or recipient of the media content), or a combination thereof). The ML model(s) 1825 can generate the media characteristic(s) 1835 based on the information 1810 and/or other types of input(s) 1805 (e.g., previous output(s) 1815). In some examples, the media characteristic(s) 1835 can be used as part of the input(s) 1805 to the ML model(s) 1825 (e.g., as part of previous output(s) 1815) for identifying the plurality of data element(s) 1840, for identifying a further media characteristic(s) 1835, and/or for generating other output(s) 1830. In some examples, at least some of the previous output(s) 1815 in the input(s) 1805 represent previously-identified score(s) that are input into the ML model(s) 1825 to identify the media characteristic(s) 1835, the plurality of data element(s) 1840, and/or other output(s) 1830. In some examples, based on receipt of the input(s) 1805, the ML model(s) 1825 can select the output(s) 1830 from a list of possible outputs, for instance by ranking the list of possible outputs by likelihood, probability, and/or confidence based on the input(s) 1805. In some examples, based on receipt of the input(s) 1805, the ML model(s) 1825 can identify the output(s) 1830 at least in part using generative artificial intelligence (AI) content generation techniques, for instance using an LLM to generate custom text and/or graphics identifying the output(s) 1830.

In some examples, the ML system 1800 repeats the process illustrated in FIG. 18 multiple times to generate the output(s) 1830 in multiple passes, using some of the output(s) 1830 from earlier passes as some of the input(s) 1805 in later passes (e.g., as some of the previous output(s) 1815). For instance, in a first illustrative example, in a first pass, the ML model(s) 1825 can identify the media characteristic(s) 1835 based on input of the information 1810 into the ML model(s) 1825. In a second pass, the ML model(s) 1825 can identify the plurality of data element(s) 1840 based on input of the information 1810 and the previous output(s) 1815 (that includes the media characteristic(s) 1835 from the first pass) into the ML model(s) 1825. In a third pass, the ML model(s) 1825 can identify the arrangement(s) 1842 of the plurality of data element(s) 1840 based on input of the information 1810 and the previous output(s) 1815 (that includes the media characteristic(s) 1835 from the first pass and/or the data clement(s) 1840 from the second pass) into the ML model(s) 1825.

In some examples, the ML system includes one or more feedback engine(s) 1845 that generate and/or provide feedback 1850 about the output(s) 1830. In some examples, the feedback 1850 indicates how well the output(s) 1830 align to corresponding expected output(s), how well the output(s) 1830 serve their intended purpose, or a combination thereof. In some examples, the feedback engine(s) 1845 include loss function(s), reward model(s) (e.g., other ML model(s) that are used to score the output(s) 1830), discriminator(s), error function(s) (e.g., in back-propagation), user interface feedback received via a user interface from a user, or a combination thereof. In some examples, the feedback 1850 can include one or more alignment score(s) that score a level of alignment between the output(s) 1830 and the expected output(s) and/or intended purpose.

The ML engine 1820 of the ML system can update (further train) the ML model(s) 1825 based on the feedback 1850 to perform an update 1855 (e.g., further training) of the ML model(s) 1825 based on the feedback 1850. In some examples, the feedback 1850 includes positive feedback, for instance indicating that the output(s) 1830 closely align with expected output(s) and/or that the output(s) 1830 serve their intended purpose. In some examples, the feedback 1850 includes negative feedback, for instance indicating a mismatch between the output(s) 1830 and the expected output(s), and/or that the output(s) 1830 do not serve their intended purpose. For instance, high amounts of loss and/or error (e.g., exceeding a threshold) can be interpreted as negative feedback, while low amounts of loss and/or error (e.g., less than a threshold) can be interpreted as positive feedback. Similarly, high amounts of alignment (e.g., exceeding a threshold) can be interpreted as positive feedback, while low amounts of alignment (e.g., less than a threshold) can be interpreted as negative feedback.

In response to positive feedback in the feedback 1850, the ML engine 1820 can perform the update 1855 to update the ML model(s) 1825 to strengthen and/or reinforce weights (and/or connections and/or hyperparameters) associated with generation of the output(s) 1830 to encourage the ML engine 1820 to generate similar output(s) 1830 given similar input(s) 1805. In this way, the update 1855 can improve the ML model(s) 1825 itself by improving the accuracy of the ML model(s) 1825 in generating output(s) 1830 that are similarly accurate given similar input(s) 1805. In response to negative feedback in the feedback 1850, the ML engine 1820 can perform the update 1855 to update the ML model(s) 1825 to weaken and/or remove weights (and/or connections and/or hyperparameters) associated with generation of the output(s) 1830 to discourage the ML engine 1820 from generating similar output(s) 1830 given similar input(s) 1805. In this way, the update 1855 can improve the ML model(s) 1825 itself by improving the accuracy of the ML model(s) 1825 in generating output(s) 1830 are more accurate given similar input(s) 1805. In some examples, for instance, the update 1855 can improve the accuracy of the ML model(s) 1825 in generating output(s) 1830 by reducing false positive(s) and/or false negative(s) in the output(s) 1830.

For instance, here, if the media characteristic(s) 1835 are successfully used to generate the plurality of data elements 1840 and/or the arrangement 1842, and/or the outputting of the arrangement 1842 is successful, this success can be interpreted as feedback 1850 that is positive (e.g., positive feedback). On the other hand, if the media characteristic(s) 1835 are not usable to generate the plurality of data elements 1840 and/or the arrangement 1842, and/or the outputting of the arrangement 1842 fails or is unsuccessful, this failure or lack of success can be interpreted as feedback 1850 that is negative (e.g., negative feedback). Either way, the update 1855 can improve the machine learning system 1800 and the overall system by improving the consistency with which the outputting an arrangement of at least a subset of the plurality of data elements is successful.

In some examples, the ML engine 1820 can also perform an initial training of the ML model(s) 1825 before the ML model(s) 1825 are used to generate the output(s) 1830 based on the input(s) 1805. During the initial training, the ML engine 1820 can train the ML model(s) 1825 based on training data 1860. In some examples, the training data 1860 includes examples of input(s) (of any input types discussed with respect to the input(s) 1805), output(s) (of any output types discussed with respect to the output(s) 1830), and/or feedback (of any feedback types discussed with respect to the feedback 1850). In some cases, positive feedback in the training data 1860 can be used to perform positive training, to encourage the ML model(s) 1825 to generate output(s) similar to the output(s) in the training data given input of the corresponding input(s) in the training data. In some cases, negative feedback in the training data 1860 can be used to perform negative training, to discourage the ML model(s) 1825 from generate output(s) similar to the output(s) in the training data given input of the corresponding input(s) in the training data. In some examples, the training of the ML model(s) 1825 (e.g., the initial training with the training data 1860, update(s) 1855 based on the feedback 1850, and/or other modification(s)) can include fine-turning of the ML model(s) 1825, retraining of the ML model(s) 1825, or a combination thereof.

In some examples, the ML model(s) 1825 can include an ensemble of multiple ML models, and the ML engine 1820 can curate and manage the ML model(s) 1825 in the ensemble. The ensemble can include ML model(s) 1825 that are different from one another to produce different respective outputs, which the ML engine 1820 can average (e.g., mean, median, and/or mode) to identify the output(s) 1830. In some examples, the ML engine 1820 can calculate the standard deviation of the respective outputs of the different ML model(s) 1825 in the ensemble to identify a level of confidence in the output(s) 1830. In some examples, the standard deviation can have an inverse relationship with confidence. For instance, if the respective outputs of the different ML model(s) 1825 are very different from one another (and thus have a high standard deviation above a threshold), the confidence that the output(s) 1830 are accurate may be low (e.g., below a threshold). On the other hand, if the respective outputs of the different ML model(s) 1825 are equal or very similar to one another (and thus have a low standard deviation below a threshold), the confidence that the output(s) 1830 are accurate may be high (e.g., above a threshold). In some examples, different ML models(s) 1825 in the ensemble can include different types of models. In some examples, the ensemble may include different ML model(s) 1825 that are trained to process different inputs of the input(s) 1805 and/or to generate different outputs of the output(s) 1830. For instance, in some examples, a first model (or set of models) can process the input(s) 1805 to generate the media characteristic(s) 1835, while a second model (or set of models) can process the input(s) 1805 to generate the plurality of data element(s) 1840. In some examples, the ML engine 1820 can choose specific ML model(s) 1825 to be included in the ensemble because the chosen ML model(s) 1825 are effective at accurately processing particular types of input(s) 1805, are effective at accurately generating particular types of output(s) 1830, are generally accurate, process input(s) 1805 quickly, generate output(s) 1830 quickly, are computationally efficient, have higher or lower degrees of uncertainty than other models in the ensemble, or a combination thereof.

In some examples, one or more of the ML model(s) 1825 can be initialized with weights, connections, and/or hyperparameters that are selected randomly. This can be referred to as random initialization. These weights, connections, and/or hyperparameters are modified over time through training (e.g., initial training with the training data 1860 and/or update(s) 1855 based on the feedback 1850), but the random initialization can still influence the way the ML model(s) 1825 process data, and thus can still cause different ML model(s) 1825 (with different random initializations) to produce different output(s) 1830. Thus, in some examples, different ML model(s) 1825 in an ensemble can have different random initializations.

As an ML model (of the ML model(s) 1825) is trained (e.g., along the initial training with the training data 1860, update(s) 1855 based on the feedback 1850, and/or other modification(s)), different versions of the ML model at different stages of training can be referred to as checkpoints. In some examples, after each new update to a model (e.g., update 1855) generates a new checkpoint for the model, the ML engine 1820 tests the new checkpoint (e.g., against testing data and/or validation data where the correct output(s) are known) to identify whether the new checkpoint improves over older checkpoints or not, and/or if the new checkpoint introduces new errors (e.g., false positive(s) and/or false negative(s)). This testing can be referred to as checkpoint benchmark scoring. In some examples, in checkpoint benchmark scoring, the ML engine 1820 produces a benchmark score for one or more checkpoint(s) of one or more ML model(s) 1825, and keeps the checkpoint(s) that have the best (e.g., highest or lowest) benchmark scores in the ensemble. In some examples, if a new checkpoint is worse than an older checkpoint, the ML engine 1820 can revert to the older checkpoint. The benchmark score for a can represent a level of accuracy of the checkpoint and/or number of errors (e.g., false positive or false negative) by the checkpoint during the testing (e.g., against the testing data and/or the validation data). In some examples, an ensemble of the ML model(s) 1825 can include multiple checkpoints of the same ML model.

In some examples, the ML model(s) 1825 can be modified, either through the initial training (with the training data 1860), an update 1855 based on the feedback 1850, or another modification to introduce randomness, variability, and/or uncertainty into an ensemble of the ML model(s) 1825. In some examples, such modification(s) to the ML model(s) 1825 can include dropout (e.g., Monte Carlo dropout), in which one or more weights or connections are selected at random and removed. In some examples, dropout can also be performed during inference, for instance to modify the output(s) 1830 generated by the ML model(s) 1825. The term Bayesian Machine Learning (BML) can refer to random dropout, random initialization, and/or other randomization-based modifications to the ML model(s) 1825. In some examples, the modification(s) to the ML model(s) 1825 can include a hyperparameter search and/or adjustment of hyperparameters. The hyperparameter search can involve training and/or updating different ML models 1825 with different values for hyperparameters and evaluating the relative performance of the ML models 1825 (e.g., against (e.g., against testing data and/or validation data where the correct output(s) are known) to identify which of the ML models 1825 performs best. Hyperparameters can include, for instance, temperature (e.g., influencing level creativity and/or randomness), top P (e.g., influencing level creativity and/or randomness), frequency penalty (e.g., to prevent repetitive language between one of the output(s) 1830 and another), presence penalty (e.g., to encourage the ML model(s) 1825 to introduce new data in the output(s) 1830), other parameters or settings, or a combination thereof.

In some examples, the ML engine 1820 can perform retrieval-augmented generation (RAG) using the model(s) 1825. For instance, in some examples, the ML engine 1820 can pre-process the input(s) 1805 by retrieving additional information from one or more data store(s) (e.g., any of the databases and/or other data structures discussed herein) and using the additional information to enhance the input(s) 1805 before the input(s) 1805 are processed by the ML model(s) 1825 to generate the output(s) 1830. For instance, in some examples, the enhanced versions of the input(s) 1805 can include the additional information that the ML engine 1820 retrieved from the from one or more data store(s). In some examples, this RAG process provides the ML model(s) 1825 with more relevant information, allowing the ML model(s) 1825 to generate more accurate and/or personalized output(s) 1830.

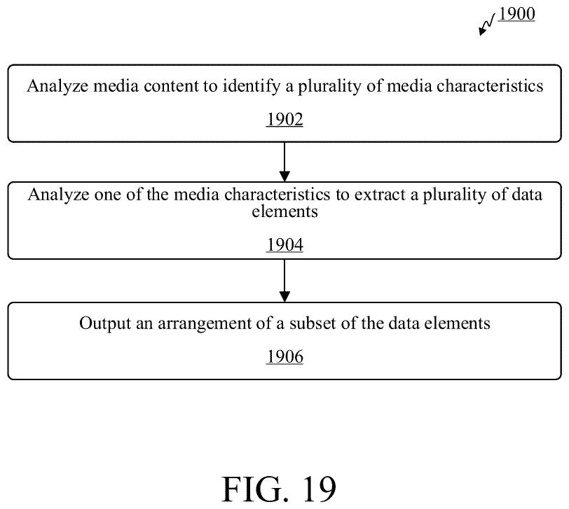

FIG. 19 is a flow diagram illustrating an example of an operation for audio processing. The operation is performed using an analysis system, which may include, for instance, the media attribution system 100, the first system 102, the server system 118, the second system 136, the user device 144, system(s) that perform any of the process(es) illustrated in the flowcharts of FIGS. 9-17, a computing system and/or computing device with at least one processor performing instructions stored in at least one memory (and/or in a non-transitory computer-readable storage medium), a system, and apparatus, or a combination thereof. In some examples, additional modules, such as an attribution handler module, a manufacturer/creator validator module, a publisher module, outside platform module (e.g., platform connector module, a platform listener module, a platform recorder module, or a combination thereof), or a combination thereof, can be incorporated as part of the media attribution system 100.

At operation 1902, the analysis system analyzes media content to identify a plurality of media characteristics of the media content. In some examples, the media content may include video content, image content, text content, building architecture, physical or digital construction, and/or other forms of creative expression, or a combination thereof. In some examples, the audio content may include music (e.g., songs, albums), speeches, audio recordings, meetings, phone calls, notes, or a combination thereof. In some examples, the image content may include photos, paintings, digital artwork, or a combination thereof. In some examples, the text content may include poems, books, emails, text messages, speeches, notes, or a combination thereof. In examples where the media content includes audio, the media characteristics may include a melody, a harmony, a bridge, a chorus, audio format, voice identification (e.g., whose voice is in the audio), subject (e.g., what is recorded in the audio), or a combination thereof. In examples where the media content includes an image, the media characteristics may include a resolution, a dimensions, colors, a tone, luminosity, pixel density, color saturation, brightness, contrast, subject (e.g., what is photographed and/or depicted in the image), image format, or a combination thereof. In examples where the media content includes a video, the media characteristics may include an aspect ratio, frames, video quality, video length, frame rate, video codec used, video format, refresh rate, subject (e.g., what is photographed and/or depicted in the video), any of the media characteristics listed above for image characteristics, or a combination thereof. In examples where the media content includes text, the media characteristics may include a heading, a title, a typography, a structure, length, language, font, subject (e.g., what is described or discussed in the text), or a combination thereof. In some examples, the media content may include a combination of media types, and/or the media characteristics may include a combination of media characteristics associated with the different media types. In some examples, the media content may be referred to as audio data, audio content, video data, video content, image data, image content, text data, text content, or a combination thereof. In some examples, the media characteristics may be referred to as audio characteristics, video characteristics, image characteristics, text characteristics, metadata characteristics, or a combination thereof. In some examples, when the media attribution system 100 is connected to a digital platform such as a game, a music platform, an NFT platform, the identified media characteristics such as connection data, musical plays, reactions, in-game actions (e.g., kills, heals, levels cleared, skills acquired, or a combination thereof), artwork displays (e.g., human interactions, comments displayed, or a combination thereof), or a combination thereof, can be recorded. In these same examples, the connection of the media attribution system 100 and recording of the media characteristics can be done by the outside platform module (e.g., platform connector module, a platform listener module, a platform recorder module, or a combination thereof). In some examples, media characteristics can include registered or mentioned creators that are auto assigned attribution at the creation of the media content, claims and endowments by registered users of the media attribution system 100, identity of the manufacturer or creator of the media content (e.g., author, clothing designer, musician, performer, photographer, person with access, AI with access to a CPU, or a combination thereof), or a combination thereof. In some examples, the media content can be made available in a new form by defining and differentiating data, through the publisher module.

At operation 1904, the analysis system analyzes one of the plurality of media characteristics to extract a plurality of data elements. The plurality of data elements may be associated with a creation of the media content. In some examples, the data elements can be associated with a pitch, a rhythm, a tempo, a timbre, a type of melody, a melodic theme, a type of harmony, a dynamic, a form, a musical key, a musical scale, a time signature, a musical expression, a genre, a musical narrative, a song structure, a location associated with the media content (e.g., where the media content was created or edited), metadata associated with the media content, an event associated with the media content (e.g., during which the media content was created, modified, distributed, or output), or an identifier a person associated with the media content (e.g., a creator, modifier, distributor, or recipient of the media content), subject (e.g., what is represented, depicted, recorded, and/or described in the media content), any of the media characteristics discussed herein, any other data elements discussed herein, or a combination thereof. In some examples, the analysis system stores and/or maintains the plurality of data elements in at least one database (e.g., the databases of the first system 102). In some examples, the at least one database stores a source reliability score indicating a reliability of a data source. In some examples, the data elements may be referred to as SIO data elements, metadata elements, nodes of a graph associated with the media content, nodes on a timeline associated with the media content, or a combination thereof.

At operation 1906, the system outputs an arrangement of at least a subset of the plurality of data elements. In some examples, the arrangement may include at least the subset of the plurality of data elements positioned along a timeline or graph. In some examples, the system outputs an arrangement of at least a subset of the plurality of data elements based on a query received by the analysis system. In this same example, the analysis system selects at least one of the plurality of data elements received, searches through the plurality of data elements stored in the at least one database of the first system 102, identifies data elements stored in the at least one of the databases that match the selected data elements, and outputs the selected data elements that match.

In some examples, the analysis system receives a query (e.g., via user interface) inquiring as to whether a particular data element is true or correct, if the data element aligns with and/or matches with other a particular story (e.g., timeline, graph, set of data elements), and/or as to the source reliability score. The analysis system can answer the query by answering whether the particular data element is true or correct, if the data element aligns and/or matches with other the particular story (e.g., timeline, graph, set of data elements), and/or by determining a source reliability score. For instance, the answer can determine whether a selected subject from the subject database 110 matches description in received data element through a query associated with the subject module 122. In an illustrative example, the analysis system can take into account source reliability score(s) associated with a particular data element (e.g., a user who submitted a particular data element) in answering the query. For instance, if a data element is submitted by a user with a low degree of reliability, the analysis system can identify that the data element is likely to be untrue or if the reliability of the user is low based on limited information, the source reliability score of the user is incomplete or limited. In another illustrative example, the analysis system can identify that a particular contribution (e.g., associated with a specific media content data element) is untrue and doesn't align with a story or timeline because a particular person could not have been present at a specific music event because that person was known to be at a different location at the same time, and the like.

What is claimed is:

1. A method for media processing, the method comprising:
analyzing media content to identify a plurality of media characteristics of the media content;
analyzing one of the plurality of media characteristics to extract a plurality of data elements, wherein the plurality of data elements is associated with a creation of the media content; and
outputting an arrangement of at least a subset of the plurality of data elements.

2. The method of claim 1, further comprising receiving the media content, wherein the media content includes audio content, and wherein the plurality of media characteristics include audio characteristics.

3. The method of claim 2, wherein the audio characteristics include at least one of a bridge, a chorus, a melody, or a harmony.

4. The method of claim 2, wherein the audio characteristics includes at least one of a pitch, a rhythm, a tempo, a timbre, a musical key, or a genre.

5. The method of claim 1, further comprising identifying a type of the media content, wherein the type is one of an original, a derivative, a remix, or a modification.

6. The method of claim 1, wherein the media content includes at least one of a video content, image content, or a text content.

7. The method of claim 1, further comprising storing the plurality of data elements in at least one database.

8. The method of claim 1, further comprising generating a source reliability score indicating a reliability of a data source.

9. The method of claim 1, further comprising:
identifying an additional media characteristic in the media content; and
analyzing the additional media characteristic to extract one or more additional data elements associated with a creation of the media content.

10. The method of claim 1, further comprising:
receiving a query;
selecting at least one of the plurality of data elements;
searching through the plurality of data elements stored in a database using the query;
identifying data elements stored in the database matching the at least one of the plurality of data elements selected; and
outputting a search result corresponding to the query, wherein the search result is associated with one or more of the plurality of data elements.

11. The method of claim 10, wherein outputting the arrangement includes outputting the search result.

12. The method of claim 10, further comprising retrieving the search result from the database.

13. The method of claim 1, wherein the arrangement includes at least the subset of the plurality of data elements positioned along a timeline.

14. The method of claim 1, wherein analyzing the media content to identify the plurality of media characteristics includes processing the media content using a trained machine learning model to identify the plurality of media characteristics.

15. The method of claim 14, further comprising updating the trained machine learning model based on feedback associated with the media characteristics.

16. The method of claim 1, wherein analyzing the plurality of media characteristics to extract a plurality of data elements includes processing the plurality of media characteristics using a trained machine learning model to extract a plurality of data elements.

17. The method of claim 16, further comprising updating the trained machine learning model based on feedback associated with the plurality of data elements.

18. The method of claim 1, wherein the plurality of data elements includes at least one of a genre, a tempo, a pitch, a type of harmony, a location associated with the media content, metadata associated with the media content, an event associated with the media content, or an identifier of a person associated with the media content.

19. A system for media processing, the system comprising:
a memory that stores instructions; and
a processor that executes the instructions, wherein execution of the instructions by the processor causes the processor to:
analyze media content to identify a plurality of media characteristics of the media content;
analyze one of the plurality of media characteristics to extract a plurality of data elements, wherein the plurality of data elements is associated with a creation of the media content; and
output an arrangement of at least a subset of the plurality of data elements.

20. A non-transitory computer-readable storage medium, having embodied thereon a program executable by a processor to perform a method for media processing, the method comprising:
analyzing media content to identify a plurality of media characteristics of the media content;
analyzing one of the plurality of media characteristics to extract a plurality of data elements, wherein the plurality of data elements is associated with a creation of the media content; and
outputting an arrangement of at least a subset of the plurality of data elements.
